(19) United States
(12) Patent Application Publication
(10) Pub. No.: US 2025/0324983 A1
(43) Pub. Date: Oct. 23, 2025

(54) METHOD AND APPARATUS FOR CONTROLLING ARTHROPODS USING MASSOIA ESSENTIAL OIL AND RELATED PYRONES

(71) Applicants: The United States of America, as Represented by the Secretary of Agriculture, Washington, DC (US); THERMACELL REPELLENTS INC, BEDFORD, MA (US)

(72) Inventors: EDMUND J. NORRIS, GAINESVILLE, FL (US); ROBERT L. ALDRIDGE, GAINESVILLE, FL (US); DANIEL L. KLINE, GAINESVILLE, FL (US); KENNETH LINTHICUM, GAINESVILLE, FL (US); SETH GIBSON, GREENVILLE, SC (US); JOHN HAINZE, SEATTLE, WA (US); BENJAMIN MCMILLAN, GAINESVILLE, FL (US); JEFFREY C. HERTZ, GAINESVILLE, FL (US)

(21) Appl. No.: 18/640,978

(22) Filed: Apr. 19, 2024

(51) Int. Cl. A01N 65/24; A01N 25/08; A01N 43/16; A01P 7/04; A01P 17/00

(52) U.S. Cl. CPC A01N 65/24; A01N 25/08; A01N 43/16; A01P 7/04; A01P 17/00

(57) ABSTRACT

Disclosed are methods of repelling one or more arthropod by treating an object or area with a composition comprising an arthropod repelling effective amount of massoia essential oil, one or more massoia essential oil component (e.g., massoia lactone), and/or analog(s) thereof (e.g., α-amyl-pyrone). Also disclosed are arthropod repellent systems with an applicator for applying an arthropod repelling effective amount of the composition to an object or area. In some embodiments, the applicator comprises a substrate impregnated with the composition and from which the composition evaporates. In some embodiments, the applicator further comprises a heating element operative to apply heat to the substrate. Further disclosed are methods of controlling one or more arthropod by contacting an arthropod or its environment with an insecticide composition comprising an arthropod killing effective amount of massoia essential oil, one or more massoia essential oil components, and/or analog(s) thereof.

### BACKGROUND OF THE INVENTION

Disclosed are methods of repelling one or more arthropod by treating an object or area with a composition comprising an arthropod repelling effective amount of massoia essential oil (EO), one or more massoia essential oil component (e.g., massoia lactone), and/or analog(s) thereof (e.g., α-amyl-pyrone). In some embodiments, the composition is applied to a substrate. In some embodiments, the method further comprises applying heat to the substrate. Also disclosed are arthropod repellent systems with an applicator for applying an arthropod repelling effective amount of the composition to an object or area. In some embodiments, the applicator comprises a substrate impregnated with the composition and from which the composition evaporates. In some embodiments, the applicator further comprises a heating element operative to apply heat to the substrate.

Further disclosed are methods of controlling one or more arthropod by contacting an arthropod or its environment with an insecticide composition comprising an arthropod killing effective amount of massoia essential oil, one or more massoia essential oil components, and/or analog(s) thereof.

As spatial repellents become an ever more utilized means to deter hematophagous arthropods from biting and spreading animal and human diseases, new technologies are needed to expand this exciting product class. This is especially true as the primary, current spatial repellent product class relies entirely on synthetic pyrethroids, to which there is significant insecticide resistance documented in the field. The inventors have identified a natural product (i.e., massoia essential oil), its constituent chemistries, and analogs thereof as potent spatial repellents against mosquitoes, biting flies, and other hematophagous arthropods. Compositions containing these active spatial repellent ingredients are not only effective in the laboratory, but the inventors have demonstrated their utility in semi-field and field environments. The chemistries highlighted within this document are distinct from chemical products on the market today, and therefore likely operate via a novel mode of action. As such little resistance is expected to these new repellent molecules in wild field populations, and the inventors have demonstrated no resistance to these compounds in a pyrethroid resistant laboratory mosquito strain. These chemistries, thus, could prevent the spread of vector-borne disease to livestock and human beings from pestiferous arthropods. The inventors envision their use both alone or in combination with current spatial repellent molecules on the market today and therefore could synergistically protect livestock, farm workers, outdoorspeople (e.g., outdoor recreationists), and military personnel in the field. Finally, as their unique chemical structures indicate a novel mode of action, little cross resistance to current pest control technologies is expected. This means that these chemistries will be useful even after current product chemistries fail due to insecticide-resistance in the field.

Natural products, such as plant essential oils (EOs), have been suggested for use as insecticides. See, for example, Norris et al., “Comparison of the Insecticidal Characteristics of Commercially Available Plant Essential Oils Against Aedes aegypti and Anopheles gambiae (Diptera: Culicidae)”, Journal of Medical Entomology, 52 (5): 993-1002 (2015), in which Ae. aegypti and An. gambiae were treated with commercially available plant essential oils via topical application. Tested against these two mosquito species were a myriad of commercially available plant essential oils, which did not include massoia essential oil. The relative toxicity of each essential oil was determined, as measured by the 24-h LD₅₀ and percentage knockdown at 1 h, as compared with a variety of synthetic pyrethroids. For Ae. aegypti, the most toxic essential oil (patchouli oil) was approximately 1,700-times less toxic than the least toxic synthetic pyrethroid, bifenthrin. For An. gambiae, the most toxic essential oil (patchouli oil) was approximately 685-times less toxic than the least toxic synthetic pyrethroid. Norris et al. (2015) demonstrated the apparent limited potency of plant essential oils compared to other synthetic insect control chemistries.

In addition, plant essential oils have been suggested for use as larvicides. See, for example, Seo et al., “Development of cellulose nanocrystal-stabilized Pickering emulsions of massoia and nutmeg essential oils for the control of Aedes albopictus”, Scientific Reports, 11:12038 (2021), in which the larvicidal potential of ten plant essential oils against Aedes albopictus was investigated. Among the essential oils tested, Seo et al. found larvicidal activity against Ae. albopictus was strongest in those essential oils derived from massoia (Massoia aromatica) and nutmeg (Myristica fragrans). The respective larvicidal activities of massoia essential oil and nutmeg essential oil against Ae. albopictus were 95.0% and 85.0% at 50 μg/mL. A total of 4 and 14 compounds were identified in Seo et al. from massoia and nutmeg, respectively, and two massoia lactones (C10 massoia lactone and C12 massoia lactone) were isolated from massoia essential oil. Among the identified compounds, benzyl salicylate, terpinolene, C12 massoia lactone, sabinene, benzyl benzoate, methyl eugenol, and C10 massoia lactone exhibited strong larvicidal activity. To overcome the insolubility of essential oils in water, Seo et al. employed cellulose nanocrystal (CNC)-stabilized Pickering emulsions (PEs) of massoia and nutmeg essential oils (i.e., CNC/massoia PE and CNC/nutmeg PE). However, Seo et al. did not disclose or suggest the use of massoia essential oil (or the identified compounds) beyond its use as a larvicide (in the form of a CNC-stabilized PE of massoia essential oil) against mosquitoes.

While natural products have been suggested for use as spatial and contact repellents, few products with high efficacy have successfully been developed and deployed on the market. This lack of natural products on the market today is likely due to their apparent limited potency compared to other synthetic insect control chemistries. However, insecticide resistance and the continued push for safer and more natural chemistries by regulatory bodies and stakeholders alike indicate that there is growing market share for natural products worldwide. In 2014, the estimated market share of natural product insecticides was approximately $500 million globally. This estimate has certainly only grown in recent years. The compounds and oils identified in this document have been shown by the inventors to repel mosquitoes in the laboratory and mosquitoes, biting midges, and biting flies in the field, as well as filth-breeding non-biting but nuisance and enteric pathogen spreading flies like house flies, demonstrating their potential to repel and control insects in real-world environments. While the inventors have demonstrated their utility on mosquitoes, biting midges, and biting flies, it is likely they may also serve as potent repellents against diverse pestiferous arthropods, such as Leptotrombidium mites (vector for scrub typhus), Sarcoptid mites, Triatomine “kissing” bugs (vector for Chagas disease), Liohippelates (eye gnats), Sarcophagidae (flesh flies), Calliphoridae (carrion flies), Simuliidae (black flies), Glossinidae (‘Tse-tse” fly), Cimicidae (bed bugs), Psychodid (phlebotomine) flies (sand flies), Tabanidae (horse-flies and deer flies), wasps, cockroaches, and ticks.

### SUMMARY OF THE INVENTION

In accordance with some embodiments of the present invention, a method of repelling one or more arthropod comprises treating an object or area with a composition comprising an arthropod repelling effective amount of massoia essential oil, one or more massoia essential oil component, and/or analog(s) thereof. In some embodiments, the composition is applied to a substrate. In some embodiments, the method further comprises applying heat to the substrate. In some embodiments, the composition is applied via fogging, ultra-low volume spray, indoor residual spray, space spray, or other suitable conventional application techniques.

In accordance with some embodiments of the present invention, an arthropod repellent system comprises an applicator for applying an arthropod repelling effective amount of a composition to an object or area, the composition comprising massoia essential oil, one or more massoia essential oil component, and/or analog(s) thereof. In some embodiments, the applicator comprises a substrate impregnated with the composition and from which the composition evaporates. In some embodiments, the applicator further comprises a heating element operative to apply heat to the substrate. In some embodiments, the composition is applied using fogger, ultra-low volume sprayer, indoor residual sprayer, space sprayer, or other suitable conventional application devices.

In accordance with some embodiments of the present invention, a method of controlling one or more arthropod comprises contacting an arthropod or its environment with an insecticide composition comprising an arthropod killing effective amount of massoia essential oil, one or more massoia essential oil components, and/or analog(s) thereof.

This summary is provided to introduce a selection of concepts in a simplified form that are further described below in the detailed description. This summary is not intended to identify key features of the claimed subject matter, nor is intended as an aid in determining the scope of the claimed invention.

### BRIEF DESCRIPTION OF THE SEVERAL VIEWS OF THE DRAWINGS

Embodiments will hereinafter be described in conjunction with the appended drawings, where like designations denote like elements.

FIG. 1 is a GC/MS chromatograph of massoia bark essential oil highlighting its primary constituents, limited to those constituents comprising at least 0.5% of relative total, one or more of which primary constituents may be utilized for repelling or otherwise controlling one or more arthropod, according to one or more embodiments.

FIG. 2 depicts spatial repellency of various plant oils, including massoia bark essential oil according to one or more embodiments, and the commercial standard IR3535 (ethyl butylacetylaminopropionate) against Aedes aegypti using a high-throughput glass tube assay.

FIG. 3 depicts spatial repellency and repellency EC₅₀ values of massoia bark essential oil and massoia lactone, according to one or more embodiments, against Aedes aegypti using a high-throughput glass tube assay.

FIG. 4 depicts chemical structures and repellency EC₅₀ values (against Aedes aegypti) of analogs of massoia lactone (i.e., the analogs are pyrones and lactones that are structurally similar to massoia lactone), a massoia essential oil component, one or more of which analogs may be utilized for repelling or otherwise controlling one or more arthropod, according to one or more embodiments.

FIG. 5 depicts a mosquito central nervous system recording of third-fourth-instar Aedes aegypti larvae treated with massoia bark essential oil or massoia lactone, according to one or more embodiments.

FIG. 6 is a chart depicting the number of mosquitoes re-captured up to 18 hr after release in semi-field enclosures that had untreated (control) or massoia bark essential oil-treated cotton dental wicks, according to one or more embodiments, surrounding BG Sentinel traps.

FIG. 7 is a chart depicting the mean number of mosquitoes collected over 24-hr collection periods across 4 pairs of control (CTRL; untreated) and treatment (trt; treated with massoia bark essential oil), according to one or more embodiments, CDC light traps located in natural habitat in a cool-temperate woodland field site in north Florida.

FIG. 8 is a chart depicting the mean number of house flies collected over 24-hr collection periods across 6 pairs of control (CTRL; untreated) and treatment (EO; treated with massoia bark essential oil), according to one or more embodiments, CDC light traps located in natural habitat in a cool-temperate woodland field site in north Florida.

FIGS. 9A-9C depict spatial repellency of massoia bark essential oil when heated to a temperature (155° F.) approximately double that of room temperature, according to one or more embodiments. FIG. 9A is a schematic image of a repellency assay modified with multiple heating elements to increase the temperature of filter paper treated with massoia bark essential oil, according to one or more embodiments. FIG. 9B is a calibration curve of the modified repellency assay of FIG. 9A. FIG. 9C is a table demonstrating spatial repellency of massoia bark essential oil is significantly increased at all timepoints when heated, according to one or more embodiments, compared to an otherwise identical repellency assay at room temperature (passive emanation).

FIGS. 10-12 are cross-sectional, exploded, and enlarged views, respectively, of an exemplary repellent dispensing device that may be utilized for treating an area with a composition comprising an arthropod repelling effective amount of massoia essential oil, one or more massoia essential oil component, and/or one or more analog of the one or more massoia essential oil component, according to one or more embodiments.

FIG. 13 is a schematic perspective view of an exemplary tick control tube containing a substrate impregnated with an insecticide composition comprising an arthropod killing effective amount of massoia essential oil, one or more massoia essential oil component, and/or one or more analog of the one or more massoia essential oil component, according to one or more embodiments.

### DETAILED DESCRIPTION

Disclosed are methods of repelling one or more arthropod by treating an object or area with a composition comprising an arthropod repelling effective amount of massoia essential oil, one or more massoia essential oil component (e.g., massoia lactone), and/or analog(s) thereof (e.g., α-amyl-pyrone). Also disclosed are arthropod repellent systems with an applicator for applying an arthropod repelling effective amount of the composition to an object or area. In some embodiments, the applicator comprises a substrate impregnated with the composition and from which the composition evaporates. In some embodiments, the applicator further comprises a heating element operative to apply heat to the substrate. Further disclosed are methods of controlling one or more arthropod by contacting an arthropod or its environment with an insecticide composition comprising an arthropod killing effective amount of massoia essential oil, one or more massoia essential oil components, and/or analog(s) thereof.

Initially, the inventors aimed to screen various natural products alone as spatial repellents against mosquitoes with the goal of identifying novel pest control compounds. From this project, the inventors identified an essential oil (i.e., massoia essential oil) and its constituents that represent a novel set of repellent chemistries. The inventors conducted a thorough literature review and found little mention of massoia essential oil as a pest control tool, and nothing documenting its effectiveness at repelling mosquitoes and other biting arthropods. Because of the dearth of literature available documenting the pest control efficacy of this plant oil and its constituent chemistries, the inventors continued to explore its potential and the potential of its primary constituents, e.g., massoia lactone, and select analogs thereof (α-amyl-pyrone and related lactones/pyrones), to repel (primary objective) and/or kill (secondary objective) insect vectors of human and veterinary pathogens. The inventors' findings demonstrate that massoia essential oil is a remarkably active spatial repellent, and its primary constituent, massoia lactone, is even more so. As such, massoia essential oil and one or more of its constituent compounds (e.g., massoia lactone) represent a novel spatial repellent chemistry with a new mode of action, as its constituent compounds possess very different chemical structures than other synthetic spatial repellents being researched and/or utilized commercially today. The inventors' data also suggest that select analogs of these constituents, such as α-amyl-pyrone and related lactone/pyrones, are active repellents/pest control chemistries.

Massoia bark essential oil, which is commercially available, is derived from the bark of the massoia tree (Cryptocarya massoia), which is found in Indonesia and Papua New Guinea. Typically, the bark of the massoia tree is peeled from the log using a knife, in a process known as debarking.

Massoia essential oil is obtained using conventional extraction methods well known to those skilled in the art. For example, massoia essential oil may be extracted from the dried bark of the massoia tree by water distillation (hydrodistillation), maceration, vapor distillation, and/or steaming. See, for example, Hertiani et al., “Potency of Massoia Bark in Combating Immunosuppressed-related Infection”, Pharmacognosy Magazine, 2016 May; 12(Suppl 3): S363-S370, in which massoia bark essential oil was extracted from the dried bark by steam-hydrodistillation. The extract was prepared by macerating pulverized dried bark in ethanol 95% for 24 hr, repeated once, followed by solvent evaporation. The filtrate was combined and evaporated to yield thick constituent. The essential oil was then obtained by steam-hydrodistillation and stored in a sealed dark glass vial and kept at 4° C. See also, for example, Rali et al., “Comparative Chemical Analysis of the Essential Oil Constituents in the Bark, Heartwood and Fruits of Cryptocarya massoy (Oken) Kosterm. (Lauraceae) from Papua New Guinea”, Molecules, 12, 149-154 (2007), in which massoia oil was extracted from the bark, heartwood, and fruits of the massoia tree by hydrodistillation. These individual plant parts were hydrodistilled over an 8 hr period in an all-glass standard distillation set-up.

Besides the bark part of the massoia tree, massoia tree heartwood and/or fruit may be used to produce massoia essential oil. The part of the massoia tree from which massoia essential oil is extracted affects the constituents in resulting massoia essential oil, along with a myriad of other factors, such as harvest date, cultivation area, storage period, climate, and extraction method. See, for example, Seo et al. (2021). Good quality massoia essential oil is reported to contain at least about 60% of C-10-massoia lactone (e.g., 64.8%), at least about 15% of C-12-massoia lactone (e.g., 17.4%), and up to about 13% of benzyl benzoate (e.g., 13.4%). Massoia essential oil from the heartwood of the massoia tree is reported to have high concentration of C-10-massoia lactone (e.g., 68.4%) and C-12-massoia lactone (e.g., 27.7%), but no detected benzyl benzoate. In addition, C-14-massoia lactone and δ-decalactone are also present in the massoia essential oil from the heartwood of the massoia tree in trace amounts (e.g., 1.4% and 2.5%, respectively). Essential oil from the fruit of the massoia tree is reported to have high percentage of benzyl benzoate (e.g., 65-70%), but less than 2% of C-10-massoia lactone and C-12-massoia lactone. See, for example, Rali et al. (2007).

Certain materials screened by the inventors were specifically obtained from the bark of the massoia tree. For example, the inventors screened massoia bark essential oil (i.e., essential oil obtained exclusively from the bark of the massoia tree), as well as components of massoia bark essential oil. However, as noted above, besides the bark of the massoia tree, other parts of the massoia tree (e.g., massoia tree heartwood and/or fruit) may be used in lieu of, or in addition to, the bark of the massoia tree to produce massoia essential oil. Massoia essential oil regardless of the part or parts of the massoia tree from which it was obtained likely contains the putative active constituent(s) and therefore would likely be effective as well. Unless specifically stated otherwise, the use of the term “massoia essential oil” in this document, including the claims, refers to essential oil obtained from any part or parts of the massoia tree.

In this document, the inventors demonstrate the effectiveness of massoia bark essential oil, massoia lactone (the primary constituent of massoia bark essential oil), and select chemical analogs of massoia lactone. This document demonstrates that massoia bark essential oil, massoia lactone, and select analogs of massoia lactone (α-amyl-pyrone, specifically) are particularly active natural product pest control tools, both as repellents (primary objective) and insecticides (secondary objective). The inventors' explorations demonstrate different types of bioactivity in each of the subsections of this document, presented below. This document also highlights the chemical structure of massoia lactone and some structurally similar chemical analogs, some of which are constituents within the massoia bark essential oil itself, and the chemical profile of the massoia bark essential oil identified using gas chromatography/mass spectroscopy (GC/MS).

The effectiveness of massoia essential oil as a particularly active natural product pest control tool demonstrated in this document may be reasonably extended to massoia essential oil obtained from any one or more element of the massoia tree. As noted above, essential oil regardless of the part or parts of the massoia tree from which it was obtained likely contains the putative active constituent(s) and therefore would likely be effective as well.

The use of trade, firm, or corporation names in this document is for the information and convenience of the reader. Such use does not constitute an official endorsement or approval by the USDA of any product or service to the exclusion of others that may be suitable.

### GC/MS Analysis of Massoia Bark Oil

### Methods

GC-MS analyses were performed on a Thermo Scientific Trace 1310 GC coupled with a Thermo Scientific ISQ7000 mass detector and equipped with a Thermo Scientific Trace Gold TG-5SILMS capillary column (30 mm, 0.25 mm inner diameter, 0.25 μm film thickness). The oven temperature program initiated at 50° C. and was held for 1 min before raising the temperature 3° C./min to 300° C., then holding for 10 min. He (99.9999%) was used as the carrier gas with a flow rate of 2.2 mL/min. The injector temperature was 250° C. with a split ratio of 1/50. Mass spectra recorded at 70 eV with a mass range from m/z 33 to 550.

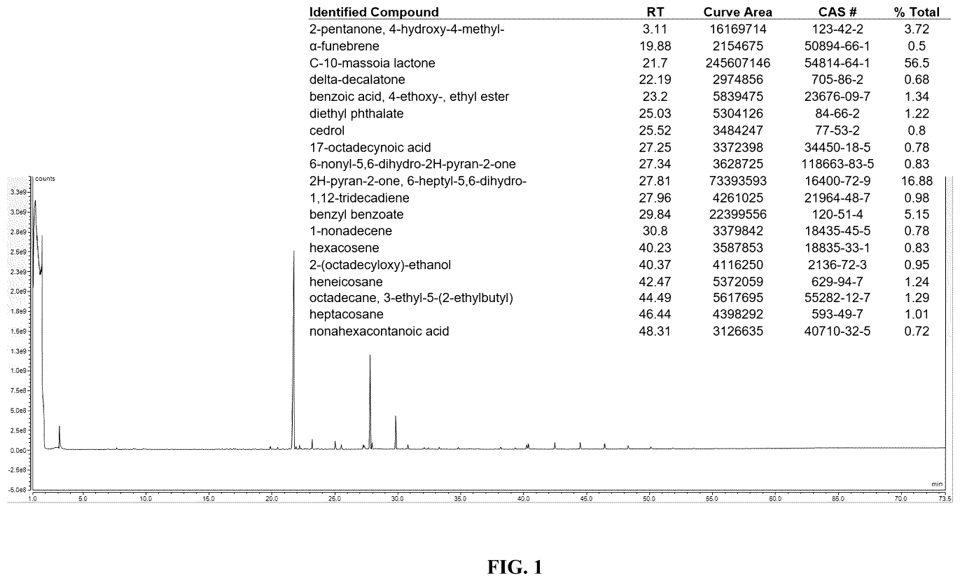

FIG. 1 is a GC/MS chromatograph of massoia bark essential oil highlighting its primary constituents, limited to those constituents comprising at least 0.5% of relative total, one or more of which primary constituents may be utilized for repelling or otherwise controlling one or more arthropod, according to one or more embodiments. Massoia lactone and 6-heptyl-5,6-dihydro-2H-pyran-2-one are the two constituents present in the highest amounts in massoia bark essential oil.

Massoia lactone (CAS Registry Number: 54814-64-1) is an alkyl lactone having the following chemical structure:

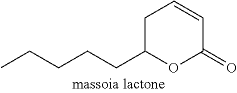

Both natural and synthetic massoia lactone are commercially available. Natural massoia lactone is typically derived from the bark of the massoia tree. As noted above, massoia lactone is the primary constituent within massoia bark essential oil. Massoia lactone is also a component of cane sugar molasses, cured tobacco, and the essential oil of sweet osmanthus (Osmanthus fragrans). In this document, including the claims, massoia lactone is also referred to as “C-10-massoia lactone” and “2H-pyran-2-one, 5,6-dihydro-6-pentyl-”. Other forms of massoia lactone beyond C-10-massoia lactone, including massoilactone (CAS Registry Number: 51154-96-2); C-12-massoia lactone and its stereoisomer 2H-pyran-2-one, 6-heptyl-5,6-dihydro-(CAS Registry Number: 16400-72-9); and C-14 massoia lactone and its stereoisomer 6-nonyl-5,6-dihydro-2H-pyran-2-one (CAS Registry Number: 118663-83-5), may be constituents of some plant oils, including massoia essential oil. Unless specifically stated otherwise, the use of the term “massoia lactone” in this document, including the claims, refers exclusively to C-10-massoia lactone.

Massoilactone (CAS Registry Number: 51154-96-2) has the following chemical structure:

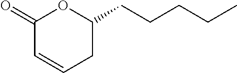

C-12-massoia lactone has the following chemical structure:

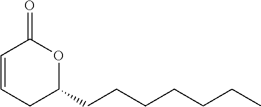

2H-pyran-2-one, 6-heptyl-5,6-dihydro-(CAS Registry Number: 16400-72-9) has the following chemical structure:

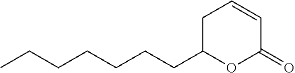

C-14-massoia lactone has the following chemical structure:

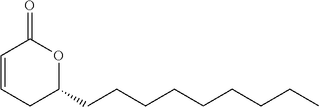 [SMILES: CCCCCCCCC[C@@H]1CC=CC(=O)O1]

6-nonyl-5,6-dihydro-2H-pyran-2-one (CAS Registry Number: 118663-83-5) has the following chemical structure:

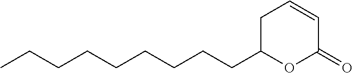 [SMILES: CCCCCCCCCC1CC=CC(=O)O1]

### Spatial Repellency Data

### Methods

Adult female non-bloodfed Aedes aegypti that were 2-10 days post-eclosion were cold-anesthetized by placing on ice for several minutes. Each replicate consisted of 16 anesthetized females transferred to a glass tube (length 12.5 cm, outer diameter 2.5 cm) (TriKinetics Inc., Waltham, MA). Glass tubes were then enclosed on each end by netting held in place with blue caps removed from 50-mL polypropylene centrifuge tubes (Falcon™; Corning Inc., Corning, NY). Mosquitoes were allowed at least 15 min to recover from cold anesthetization. Round filter papers (diameter 2.5 cm) (Sigma-Aldrich Chemical Co., CITY, ST) were treated with 50 μL solution of compound dissolved in acetone at different concentrations. Treated filter papers were allowed to air dry for 10 min to allow for acetone evaporation, at which point filter papers were placed inside the cut ends of 50-mL polypropylene centrifuge tubes. The end caps with treated filter paper were then placed on the ends of the glass tubes, replacing the blue caps, with the netting left to prevent mosquito escape.

Glass tube bioassay setups were placed on a contrasting white background to facilitate observing and counting mosquitoes with a black line drawn to mark the center of the tube length. Control bioassays were set up with filter papers treated with 50 μL of acetone. Repellency was calculated as a repellency ratio using the formula: number of mosquitoes on the experimental treatment side/16, where a value of 0 is equal to full repellency and a value of 0.5 indicates no effect—i.e., an even distribution of mosquitoes on either side the tube midline. Data were recorded at 15 min, 30 min, and 1 hr for repellency and knockdown, as well as at 24 hr for mortality. If a skewed behavioral distribution—that is, a difference larger than four mosquitoes between both halves—was observed in the negative control, which rarely occurred, the replicate was discarded. Each concentration was replicated at least three times. After use, glass tubes were decontaminated by washing in soapy water and rinsed with acetone and distilled water. Treatment caps and nettings were washed using soapy water and rinsed with distilled water. Data were analyzed using a 4-parameter logistic regression in GraphPad Prism 9. The effective concentration that repelled 50% of mosquitoes (EC₅₀) was used to compare different treatments.

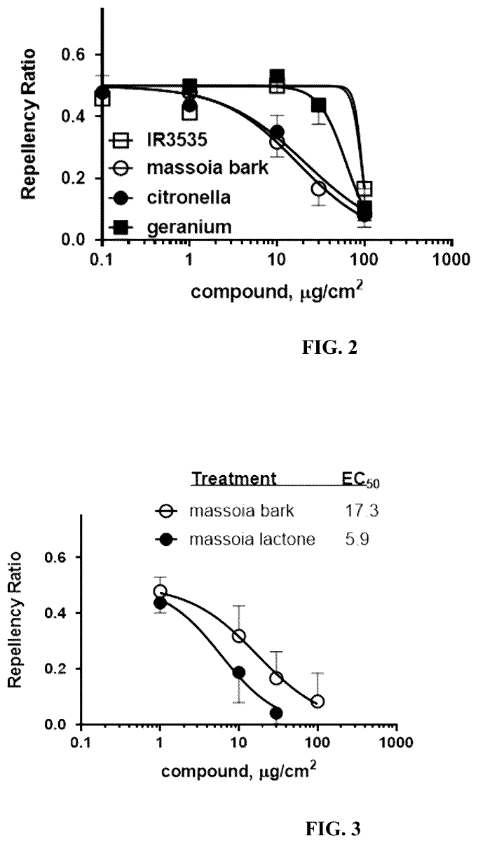

FIG. 2 depicts spatial repellency of various plant oils, including massoia bark essential oil according to one or more embodiments, and the commercial standard IR3535 (ethyl butylacetylaminopropionate) against Aedes aegypti using a high-throughput glass tube assay as described above. All the various plant oils (i.e., massoia bark, citronella, and geranium essential oils) outperformed IR3535. Both citronella and massoia bark essential oils performed considerably better than both IR3535 and geranium essential oil.

Table 1. EC₅₀ values for various plant oils and IR3535 using a high-throughput glass tube assay.

| Treatment | EC₅₀ (μg/cm²) |
|---|---|
| IR3535 | 91.8 |
| geranium | 61.7 |
| citronella | 21.1 |
| massoia bark | 17.3 |

FIG. 3 depicts spatial repellency and repellency EC₅₀ values of massoia bark essential oil and massoia lactone, according to one or more embodiments, against Aedes aegypti using a high-throughput glass tube assay as described above. Massoia lactone (EC₅₀=5.9 μg/cm²) is significantly more repellent than massoia bark essential oil (EC₅₀=17.3 μg/cm²) and, accordingly, massoia lactone may represent the primary bioactive constituent within the massoia bark essential oil.

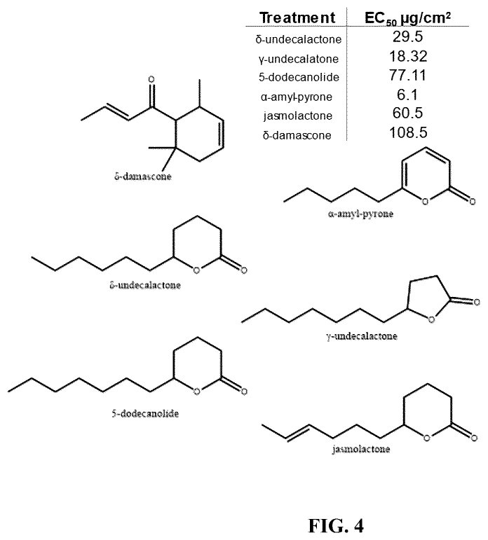

FIG. 4 depicts chemical structures and repellency EC₅₀ values (against Aedes aegypti) of analogs of massoia lactone (i.e., the analogs are pyrones and lactones that are structurally similar to massoia lactone), a massoia essential oil component, one or more of which analogs may be utilized for repelling or otherwise controlling one or more arthropod, according to one or more embodiments. The analogs of massoia lactone selected for screening included: α-amyl-pyrone; γ-undecalactone; δ-undecalactone; jasmolactone; 5-dodecanolide; and δ-damascone. A wide range of activity was observed among these compounds with α-amyl-pryone (EC₅₀=6.1 μg/cm²) being the most active of the subset screened. Following α-amyl-pryone in activity were: γ-undecalactone (EC₅₀=18.32 μg/cm²); δ-undecalactone (EC₅₀=29.5 μg/cm²); jasmolactone (EC₅₀=60.5 μg/cm²); 5-dodecanolide (EC₅₀=77.11 μg/cm²); and δ-damascone (EC₅₀=108.5 μg/cm²).

### Contact Repellency Data

### Methods

The cloth patch test can be used to assess the effective repellency duration for a particular application rate of a chemical to cloth being worn on the arm of a human subject. The test allows candidate repellents to be tested without contacting the skin. The candidate substance is dissolved initially in a suitable solvent which is typically acetone; however, can be extended to ethanol or DMSO (dimethyl sulfoxide). The typical protocol for a limited quantity of substance involves dissolving up to 75 mg of the candidate repellent into 1 mL of an appropriate volatile solvent, such as acetone or ethanol, in a 2-dram vial. The choice of solvent depends upon the miscibility characteristics of the candidate repellent. A 50 cm² (5 cm×10 cm) clean, untreated piece of muslin cloth is rolled, placed in the vial and sealed therein to allow the cloth to saturate completely with the solution. If 75 mg was dissolved, for example, this results in an applied rate (to cloth) of 1.5 mg/cm². Prior to the bioassay, the saturated cloth is removed and each end of the cloth is attached to a 5 cm×2.5 cm piece of cardstock paper. To each card, masking tape is attached. The card/cloth assembly is then allowed to dry for 15 min hanging from a rack by the masking tape. This time is adequate to allow complete evaporation of the solvent from the cloth.

To prepare the arm for testing, the volunteer first places a latex or nitrile glove (extended length beyond the wrist) over the hand and arm and then pulls a nylon hose stocking over the hand and arm up to a point that is past the elbow. This glove prevents mosquitoes from biting through to the hand, wrist, and part of the arm where the glove provides protection. A thick plastic sleeve with a Velcro® strip is then fastened around the arm. There is a 4 cm×8 cm window opening cut into the sleeve. Volunteers may elect to use either of the two designs of this sleeve: one has a window opening with a screen mesh, the other is completely open. The cloth card frame is then taped onto the forearm at a position overlapping the window opening of the sleeve. This allows attractive human odors to escape through the opened area of the sleeve and this small window is the only area accessible for bites. Once the cloth/card assembly is on the arm, the arm is placed inside an insect cage with mosquitoes or biting flies for one minute. Typically, the test involves 500 biting flies or mosquitoes, but can be performed at a variety of biting pressures from 200-2000 individuals, but is rarely ever performed at a pressure of greater than 2000 in a cage. If 5 bites or more are received during a test and on consecutive days, this indicates the failure point of the chemical as a repellent. If fewer than 5 bites were received, then the same cloth/card assembly for that chemical will be retested every 24 hr until the point that 5 bites are received on consecutive days. Regardless of whether a single repellent or group of repellents is tested, DEET (N,N-Diethyl-meta-toluamide) is usually included as the standard for comparison of results. The mosquitoes used in these bioassays are normally Aedes aegypti and Anopheles albimanus, and flies are Stomoxys calcitrans, but these may vary. Because these are laboratory-reared insects from the colony at the USDA, none of the insects are infected with human pathogens.

If a sufficient quantity of the candidate repellent is available, the minimum effective dose (MED) can be determined. The testing method is similar to that described above; however, tests are performed only on the initial 15-min dried samples and 1-d old samples for multiple cloth/card assemblies where the treatment application rate to cloth is reduced via serial dilutions (e.g., 1.5 mg/cm², 0.75 mg/cm², 0.375 mg/cm², etc.) to provide the MED. Finally, there are situations where various doses may be needed to better model the biological response. In these cases, stoichiometric equivalents, i.e., micromolar quantities, are applied to the cloth and tested as described above. The typical concentrations for these studies range from 2.5 μM/cm² down to 0.03 μM/cm², but some studies may even use lower concentrations if the repellent is still active.

Table 2. Contact repellency of massoia lactone and massoia bark essential oil (which contains massoia lactone) against permethrin, DEET, and icaridin as commercial standards for repellency. Massoia lactone was as effective as contact repellent as icaridin and DEET and was significantly more repellent than permethrin.

| Compound | MED (mg/cm²)* |
|---|---|
| massoia lactone | 0.007 ± 0.002 ^{B} |
| massoia bark essential oil | 0.023 ± 0.005 ^{A} |
| permethrin | 0.100 ± 0.022 ^{A} |
| DEET | 0.009 ± 0.003 ^{B} |
| icaridin | 0.015 ± 0.004 ^{B} |

In Table 2, letters presented alongside each value indicate statistically significant differences among treatments via an ANOVA followed by Fischer's least-significant differences test. Massoia lactone was considerably repellent, with efficacy similar to both DEET and icaridin commercial standards used in this test.

### Topical Applications Data

### Methods

Aedes aegypti mosquitoes (susceptible—Orlando strain) were reared using standard protocols at the United States Department of Agriculture, Agricultural Research Service Center for Medical, Agricultural, and Veterinary Entomology (CMAVE) in Gainesville, FL. Mosquitoes raised from pupae were aspirated from colony cages and anesthetized on ice. Mosquitoes were then treated with 0.2 μL of variable concentrations of insecticidal active ingredients using a repeating microapplicator (Hamilton Co., Reno, NV). Ten mosquitoes were used per concentration and at least three different biological cohorts were used in the analysis. Knockdown (defined as inability to fly or orient in the upright direction) was recorded at 1 hr or other time points post application (depending on the experiment), whereas mortality (defined as no movement-ataxia) was recorded at 24 hr. Concentrations that produced 10-90% mortality at 24 hr post exposure were used in the analysis to calculate the lethal dose required to kill 50% of the population (LD₅₀). SAS 9.4 was used to calculate the LD₅₀ values using a PROC PROBIT model with Abbott's correction to account for any control mortality.

Table 3. Insecticidal activity of massoia lactone and massoia bark oil compared to a relatively insecticidal plant essential oil. Patchouli oil was selected as it was the most toxic plant essential oil identified via topical applications in Norris et al. (2015).

| | | | Slope | | Slope |
|---|---|---|---|---|---|
| Treatment | N | KD₅₀ | (SE) | LD₅₀ | (SE) |
| massoia bark | 140 | 850 | 2.3 | 1100 | 3.1 |
| | | (650-2040) | (1.0) | | (0.7) |
| massoia lactone | 180 | 750 | 4.0 | 1220 | 8.3 |
| | | (610-910) | (0.6 | (940-1400) | (1.9) |
| patchouli oil* | 190 | 690 | 4.2 | 2000 | 1.9 |
| | | (540-850) | (0.9) | (930-4000) | (0.6) |

### Central Nervous System Recording

### Methods

Extracellular recordings were performed on the central nervous system (CNS) of third-fourth-instar Aedes aegypti larvae as previously described in Norris et al., “Recording central neurophysiological output from mosquito larvae for neuropharmacological and insecticide resistance studies”, Journal of Insect Physiology, 135 (2021) 104319. Mosquito larvae were pinned down and dissected to expose the descending ventral nerve cord in a saline bath (157 mM NaCl, 3 mM KCl, 2 mM CaCl₂), 4 mM HEPES). The ventral nerve cord was severed using a small forceps between the second and third abdominal ganglion. Descending electrical activity was monitored by drawing emanating nerve fibers from the ventral nerve cord into a suction electrode connected to an AC/DC differential amplifier (Model 3000, A-M Systems, Inc., Carlsborg, WA). Signals were subjected to window amplitude discrimination and converted into a rate plot, expressed in Hertz (Hz), using LabChart 7 Pro software (AD Instruments Inc. Colorado Springs, CO). Noise (60 Hz) was eliminated using a Hum Bug (A-M Systems, Sequim, WA,).

Electrical activity was monitored for approximately 5-10 min to establish a baseline CNS firing rate before test solutions were added to the bath in DMSO at 1 μL of solution diluted into 999 μL of saline. All concentrations of active ingredients were expressed as their final concentrations in saline. Each recording was performed for 30 min; a new CNS preparation was used for each treatment and replicate. The CNS firing frequency was averaged over a 3-min interval, immediately prior to the application of the tested compound (baseline) and every 1 min after the application of test compound for 30 min. Nerve firing was represented at each time point after the application of each active ingredient as the percentage of firing observed at baseline (3-min average before active ingredient application). An unpaired 1-test between individual treatments was performed to determine significant differences at discrete time points following treatment (α=0.05).

FIG. 5 depicts a mosquito CNS recording of third-fourth-instar Aedes aegypti larvae treated with massoia bark essential oil or massoia lactone, according to one or more embodiments. Massoia lactone produced some nerve block when applied at the 100 μM level. As massoia bark essential oil is approximately 56% massoia lactone by volume (determined by GC/MS), the inventors applied massoia bark essential oil at a concentration that provided 100 M of massoia lactone in the well. Significantly more nerve block was observed from this oil application compared to the lactone itself at this concentration indicating other compounds within massoia bark oil are either capable of blocking nerve firing themselves or synergize the effects of massoia lactone.

### Semi-Field Repellency Data

### Methods

The candidate spatial repellent was applied to cotton dental wicks (2 mL per cotton wick). Sixteen treated cotton wicks were hung from an approximately cubic 1.22 m×0.91 m×0.91 m PVC fixture constructed to surround a BG Sentinel trap (BioGents, Regensberg, Bayern, Germany) used to collect mosquitoes released into a (30 ft×60 ft×18 ft) screened outdoor semi-field enclosure. Three cotton wicks were hung on each of the four lateral sides of the fixture approximately 0.3 m from the ground, and 4 more treated cotton wicks were placed on a metal mesh placed over the top of the PVC fixture, directly above the opening of the BG Sentinel trap. Exactly 300 females from each of 4 mosquito species, Aedes aegypti, Aedes taeniorhynchus, Culex quinquefasciatus, and Anopheles quadrimaculatus, were released at the beginning of the experimental interval, 4 hr after the introduction of the treated dental wicks, and experiments were terminated (mosquitoes collected in BG Sentinel traps) at approximately 18 hr after introduction of mosquitoes. A control semi-field enclosure was also tested, where no treatment was provided. Total numbers of mosquitoes collected after the experimental interval in the control enclosures were compared to numbers collected in the treatment semi-field enclosures. Two semi-field enclosures were used during each test period, one serving as the untreated control. Treatment and control enclosures were rotated each test period. A minimum of 48 hr elapsed between test periods to allow the semi-field enclosures to “air out” between test periods. A replicate consisted of two test nights, i.e., the treatment collection conducted in each semi-field enclosure for one night, to account for possible location effects. Collection data for each compound were analyzed with a paired 1-test between the control and treatment groups, with significant differences declared p=0.05.

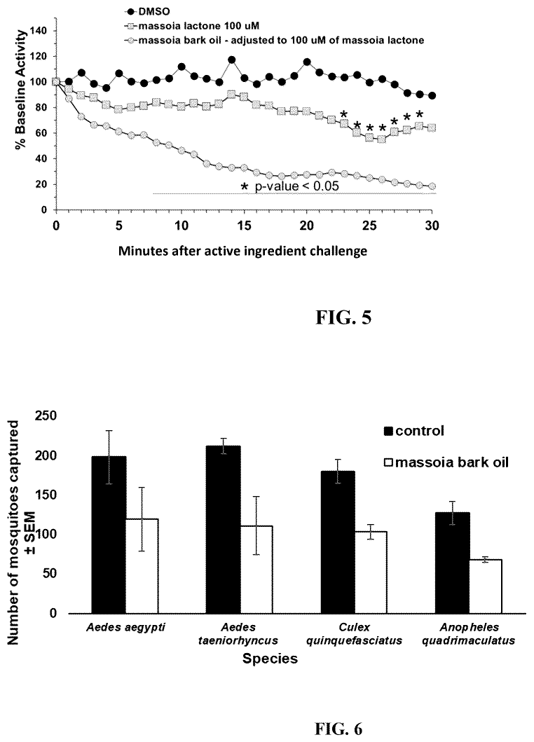

FIG. 6 is a chart depicting the number of mosquitoes re-captured up to 18 hr after release in semi-field enclosures that had untreated (control) or massoia bark essential oil-treated cotton dental wicks according to one or more embodiments, surrounding BG Sentinel traps. Significantly fewer (approximately 40%-50% reduction) mosquitoes of all four tested species were collected in semi-field enclosures that had massoia bark essential oil-treated cotton dental wicks.

### Field Repellency Efficacy

### Methods

Target and non-target organism collections were taken at a research site located north of Keystone Airport within the confines of Camp Blanding Joint Training Center, east of Starke, FL. Two modified CDC miniature light traps (Bioquip, Rancho Dominguez, CA, USA) baited with light and CO₂ were set 50 m apart from one another in 4 separate collection areas.

CDC miniature light traps were modified by adding 8⅛ in. medium aluminum blind rivets to the trap lid (14 in diameter) spaced evenly around the circumference approximately 5 in apart. The blind rivet mandrel was left intact and not “popped” off, which in turn loosely held the handle of a binder clip to hang in place. Each binder clip held a nylon tulle 4×4 in. sachet containing a cotton ball treated with 2 mL of essential oil or nothing. Control and essential oil (treatment) traps were left to run overnight suspended from a 2.18 m (86 in.) shepherd hook under a ½ gal dry ice cooler to dispense CO₂. All traps were baited with dry ice and a 3 W incandescent light source. Collection containers were made of fine aluminum mesh and nylon netting (no-see-um) to allow capture and later identification of collected arthropods.

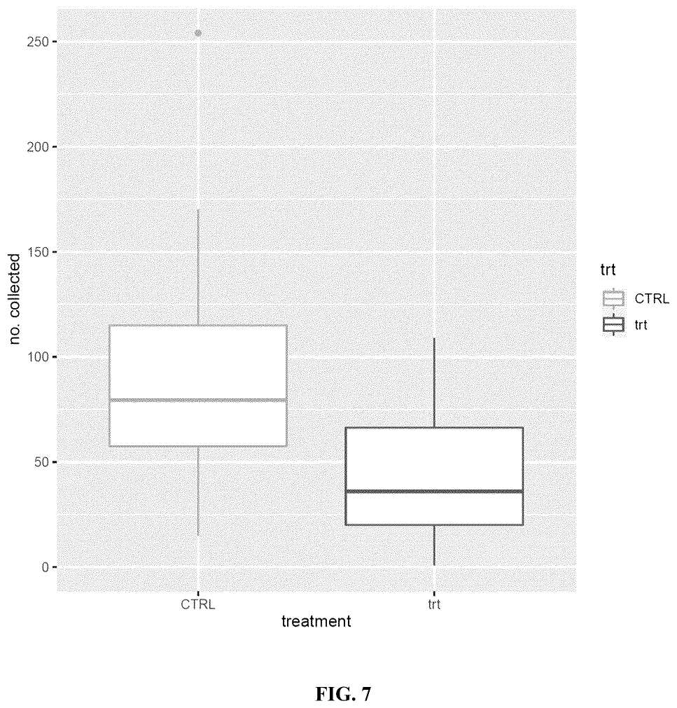

FIG. 7 is a chart depicting the mean number of mosquitoes collected over 24-hr collection periods across 4 pairs of control (CTRL; untreated) and treatment (trt; treated with massoia bark essential oil), according to one or more embodiments, CDC light traps located in natural habitat in a cool-temperate woodland field site in north Florida. An approximately 50% reduction in mosquito capture for the CDC light traps treated with massoia bark essential oil compared to the control was observed when data were averaged across all replications. These data indicate the utility of using massoia bark essential oil and its constituents against mosquitoes as spatial repellents in the field.

Table 4. Description of the number and species of female mosquitoes collected from CDC light traps with or without essential oil treatment over 4 trap nights located in the southwest corner of Camp Blanding Joint Training Center, east of Starke, FL. A significant reduction in 10 of the 13 collected mosquito species was observed.

| | | | Percent | Grand Total |
|---|---|---|---|---|
| | No. | No. | reduction | percent of |
| | individual | individual | due to | each species |
| | females | females | presence of | relative to |
| | collected in | collected in | massoia bark | the total |
| Species | Control | Treatment | essential oil | collection) |
| Ae. infirmatus | 6 | 2 | 66.7% | 8 (<1%) |
| Ae. mitchellae | 1 | 0 | 100% | 1 (<1%) |
| Ae. tormentor | 86 | 21 | 75.6% | 107 (8%) |
| Ae. vexans | 1 | 0 | 100% | 1 (<1%) |
| An. crucians | 387 | 252 | 34.9% | 639 (47%) |
| Cx. erraticus | 31 | 7 | 77.4% | 38 (3%) |
| Cx. nigripalpus | 118 | 48 | 59.3% | 166 (12%) |
| Cx. salinarius | 3 | 1 | 66.7% | 4 (<1%) |
| Cq. perturbans | 2 | 3 | −50% | 5 (<1%) |
| Cs. melanura | 311 | 63 | 79.7% | 374 (27%) |
| Ma. dyari | 0 | 1 | −100% | 1 (<1%) |
| Ma. titillans | 1 | 0 | 100% | 1 (<1%) |
| Ur. sapphirina | 5 | 22 | −340% | 27 (2%) |
| Mosquito total | 952 | 420 | 55.9% | 1372 |

Table 5. Description of the number and species of Culicoides biting midges collected from CDC light traps with or without massoia bark essential oil treatment over 4 trap nights located in the southwest corner of Camp Blanding Joint Training Center, cast of Starke, FL. A significant reduction in three of the four collected Culicoides species was observed.

| | | | Percent | Grand Total |
|---|---|---|---|---|
| | No. | No. | reduction | (percent of |
| | individual | individual | due to | each species |
| | females | females | presence of | relative to |
| | collected | collected in | massoia bark | total |
| Species | in Control | Treatment | essential oil | collected) |
| C. baueri | 178 | 2 | 98.9% | 180 (30%) |
| C. insignis | 76 | 22 | 71.1% | 98 (16%) |
| C. tissoti | 312 | 5 | 98.4% | 317 (53%) |
| C. venustus | 1 | 6 | −600% | 7 (1%) |
| Culicoides | 567 | 35 | 93.8% | 602 |
| total | | | | |

FIG. 8 is a chart depicting the mean number of house flies collected over 24-hr collection periods across 6 pairs of control (CTRL; untreated) and treatment (EO; treated with massoia bark essential oil), according to one or more embodiments, CDC light traps located in natural habitat in a cool-temperate woodland field site in north Florida. An approximately 70% reduction in house fly capture for the CDC light traps treated with massoia bark essential oil compared to the control was observed when data were averaged across all replications. These data indicate the utility of using massoia bark essential oil and its constituents as spatial repellents against house flies in the field.

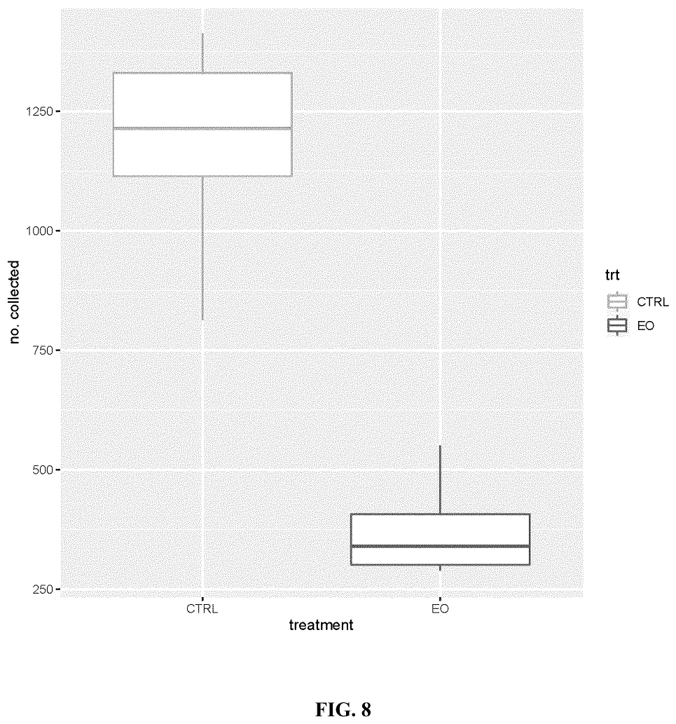

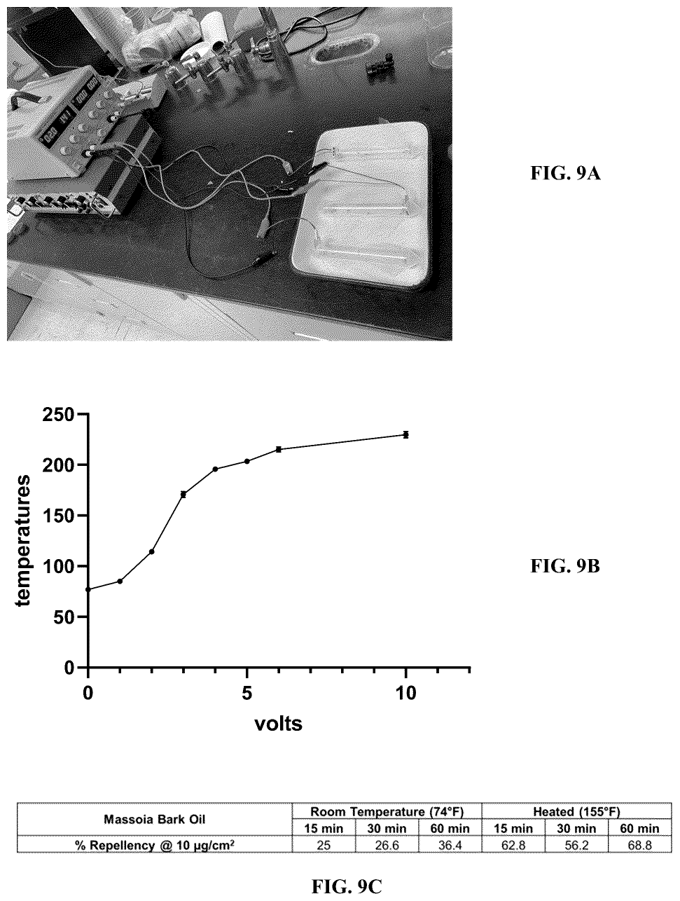

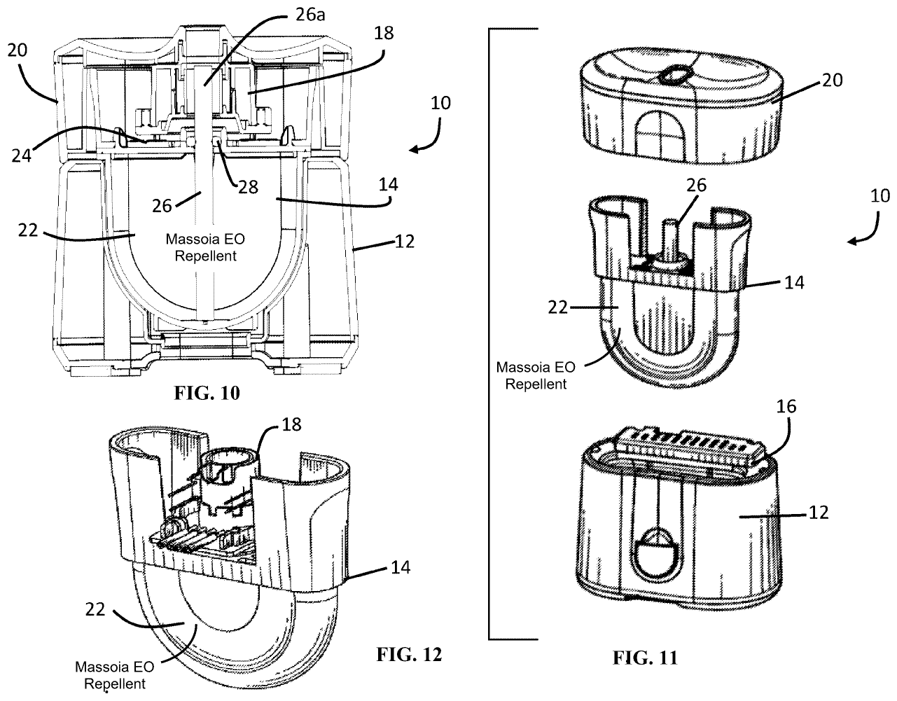

Devices. In accordance with some embodiments of the present invention, an object or an area may be treated with a composition comprising an arthropod repelling effective amount of massoia essential oil, one or more massoia essential oil component, and/or analog(s) thereof by using a source of energy. Exemplary sources of energy include, but are not limited to, the following: 1) passive emanation where the energy to generate emissions is from ambient heat energy and airflow in the environment; 2) heat energy from a burning ember, such as a mosquito coil; 3) heat energy produced through electricity by battery or line power from an outlet; 4) heat energy from burning fuel, such as butane, propane, or liquified petroleum gas (LPG); 5) heat energy from a chemical reaction, such as those used in exothermic reactions (e.g., handwarmers, MRE heaters, and the like); 6) heat energy from an electromagnetic induction device; 7) heat energy from other conventional sources (e.g., heat energy produced through electricity by solar power, hand crank generator, foot pedal generator, and the like); 8) energy generated by air flow such as a fan; and 59) energy generated by a mechanical effect, such as a vibrating plate in a piezo device. An exemplary implementation where the source of energy is heat energy produced through electricity by battery or line power from an outlet is described below in the context of the modified repellency assay of FIGS. 9A-9C. Another exemplary implementation where the source of energy is heat energy produced through electricity by battery or line power from an outlet is described below in the context of the repellent dispensing device of FIGS. 10-12.

Substrates. In accordance with some embodiments of the present invention, a composition comprising massoia essential oil, one or more massoia essential oil component, and/or analog(s) thereof may be contained in or on the surface of a substrate from which it is released into the air. A variety of substrates are possible in this regard. For example, cellulose substrates, such as paper mats, are frequently used. In another example, a composition comprising massoia essential oil, one or more massoia essential oil component, and/or analog(s) thereof may be incorporated in a polymer, natural particulate (e.g., sand), or ceramic substrate. In yet another example, a composition comprising massoia essential oil, one or more massoia essential oil component, and/or analog(s) thereof may be emitted via a capillary or conductive substance like a wooden, ceramic, or polymer-based wick. An exemplary implementation where the substrate is a wick is described below in the context of the repellent dispensing device of FIGS. 10-12. In still yet another example, a composition comprising massoia essential oil, one or more massoia essential oil component, and/or analog(s) thereof may be emitted from clothing or other textile (e.g., tentage). Other examples include, a composition comprising massoia essential oil, one or more massoia essential oil component, and/or analog(s) thereof that may be emitted from paint (e.g., incorporated in a polymer additive within the paint); military materials such as camouflage netting (e.g., incorporated in a polymer coating applied to the netting); non-woven polypropylene geotextile; and polyester, nylon or other polymer shade cloth and/or sandbags and/or shelter systems.

FIGS. 9A-9C depict spatial repellency of massoia bark essential oil when heated to a temperature approximately double that of room temperature (i.e., heated to a temperature of about 155° F.), according to one or more embodiments. FIG. 9A is a schematic image of a repellency assay modified with multiple heating elements to increase the temperature of filter paper treated with massoia bark essential oil, according to one or more embodiments. FIG. 9B is a calibration curve of the modified repellency assay of FIG. 9A. FIG. 9C is a table demonstrating spatial repellency of massoia bark essential oil is significantly increased at all timepoints when heated, according to one or more embodiments, compared to an otherwise identical repellency assay at room temperature (passive emanation).

In accordance with some embodiments of the present invention, a method of repelling one or more arthropod comprises treating an object or area with a composition comprising an arthropod repelling effective amount of massoia essential oil, one or more massoia essential oil component, and/or analog(s) thereof. In some embodiments, the composition is applied to a substrate, such as a mat or a wick. In some embodiments, the method further comprises applying heat to the substrate. In some embodiments, the composition is applied via thermal or cold fogging, ultra-low volume spray, indoor residual spray, space spray, or other suitable conventional application techniques.

In accordance with some embodiments of the present invention, an arthropod repellent system comprises an applicator for applying an arthropod repelling effective amount of a composition to an object or area, the composition comprising massoia essential oil, one or more massoia essential oil component, and/or analog(s) thereof. In some embodiments, the applicator comprises a substrate impregnated with the composition and from which the composition evaporates. For example, the substrate may be a mat or a wick comprising cellulose, polymer, and/or ceramic. In some embodiments, the applicator further comprises a heating element operative to apply heat to the substrate. In some embodiments, the composition is applied using a fogger, ultra-low volume sprayer, indoor residual sprayer, space sprayer, or other suitable conventional application device.

In accordance with some embodiments of the present invention, a method of controlling one or more arthropod comprises contacting an arthropod or its environment with a composition comprising an arthropod killing effective amount of massoia essential oil, one or more massoia essential oil components, and/or analog(s) thereof.

In some embodiments, the composition comprises the massoia essential oil, alone or in combination with other ingredients.

In some embodiments, the composition comprises the one or more massoia essential oil component, wherein the one or more component is/are selected from the group consisting of 4-hydroxy-4-methyl-2-pentanone; α-funebrene; 5,6-dihydro-6-pentyl-2H-pyran-2-one (massoia lactone); massoilactone; delta-decalatone; ethyl 4-ethoxybenzoate; diethyl phthalate; cedrol; 17-octadecynoic acid; 6-nonyl-5,6-dihydro-2H-pyran-2-one; C-14-massioa lactone; 6-heptyl-5,6-dihydro-2H-pyran-2-one; C-12-massioa lactone; 1,12-tridecadiene; benzyl benzoate; 1-nonadecene; hexacosene; 2-(ocyadecyloxy)-ethanol; heneicosane; 3-ethyl-5-(2-ethylbutyl) octadecane; heptacosane; and nonahexacontanoic acid. In such embodiments, the composition may comprise the one or more massoia essential oil component alone, or in combination with other ingredients. In some embodiments, the composition comprises at least massoia lactone as the one or more massoia essential oil component.

In some embodiments, the composition comprises the one or more analog of the one or more massoia essential oil component, wherein the one or more analog is/are selected from the group consisting of α-amyl-pyrone; γ-undecalactone; δ-undecalactone; jasmolactone; 5-dodecanolide; and δ-damascone. In such embodiments, the composition may comprise the one or more analog alone, or in combination with other ingredients. In some embodiments, the composition comprises at least α-amyl-pyrone as the one or more analog of the one or more massoia essential oil component.

Co-formulants. Other compounds (e.g., one or more suitable synergists, propellants, carriers, diluents, adjuvants, preservatives, dispersants, surfactants, solvents, and/or emulsifying agents) may be added to the composition provided they do not substantially interfere with the intended activity and efficacy of the composition; whether or not a compound interferes with activity and/or efficacy can be determined, for example, by the procedures utilized herein. Some ingredients in the composition may require an anti-oxidant to insure their stability. Suitable anti-oxidants include, but are not limited to, butylated hydroxytoluene (BHT), butylated hydroxyanisole (BHA), tocopherols, and phenolic antioxidants (e.g., available from Syensqo [CITY, STATE] under the Cyanox brand). Fragrances could also be incorporated into the composition, but fragrances typically do not have functional value.

“Carrier” as used in this document, including the claims, refers to any method of dispersal, dispensation, application, timed-release, encapsulation, microencapsulation, or the like to apply the composition as further described herein. In embodiments, such “carriers” may include a variety of microencapsulation, controlled-release, and other dispersion technologies available to those of ordinary skill in the art. For example, the composition may be encapsulated in Pickering emulsions (PEs) stabilized by solid particles, such as cellulose nanocrystals (CNCs). Encapsulation of essential oils in CNC-stabilized PEs is well known in the art. See, for example, Seo et al. (2021).

In accordance with some embodiments, a composition comprising massoia essential oil, one or more massoia essential oil component, and/or analog(s) thereof may be encapsulated within a microcapsule using techniques known to those skilled in the art, such as in situ polymerization method, a coacervation method, or an interfacial polymerization method. Materials suitable for the microspheres include, but are not limited to, urea-formaldehyde, vinylidene chloride-acrylonitrile copolymer, polyvinyl alcohol, polyvinyl butyral, polymethylmethacrylate, polyacrylonitrile, polyvinylidene chloride, polysulfone, and the like. See, for example, U.S. Pat. No. 8,741,804 B2.

In addition, the composition optionally comprises a synergist, a humectant, an emulsifier, an anti-foam agent and/or a preservative.

The composition may be formulated as an aqueous formulation or as an oleaginous formulation, depending on design. Aqueous formulations may include surfactants selected from commercially available surfactants such as (but not limited to) Libsorb, Silwet L77, Tween 80, Torpedo 11, Newmans T80, Fortune, Guard, Rhino, Biopower, and the like. Of these surfactants, Libsorb is the most preferred. Oleaginous formulations, that is to say oil-based formulations, may contain any oil suitable for use in the invention which may be selected from petroleum oils, such as paraffin oil, summer spray oils, and winter spray oils known in the art, and vegetable oils such as rapeseed oil, soybean oil, sunflower oil, palm oil, and the like. Oleaginous formulations of the invention may contain electret particles as described below and these in turn may be admixed with flow agents such as hydrophilic precipitated silicas, for example Sipernat 383 DS, Sipernat 320, EXP 4350, Sipernat D-17, and the like. Such free-flowing agents may be dispersed in oils, for example, for anti-foaming purposes.

For the purposes of the present invention, “electrets” are materials that maintain a permanent dielectric polarization, or bulk charge, rather than a surface electrostatic charge. The electret particles of use in the invention typically comprise hard waxes such as waxes having a melting point of ≥50° C., more preferably of ≥60° C., and most preferably are made up of hard waxes having a melting point of ≥70° C. Suitable electret particles comprise hydrophobic particles that may be selected from waxes such as carnauba wax, beeswax, Chinese wax, shellac wax, spermaceti wax, candelilla wax, castor wax, ouricury wax, and rice bran wax. Such waxes typically display a high enthalpy of lattice energy during melt. Oleaginous formulations of the invention may comprise electret particles having a volume mean diameter of ≥10 μm, and more preferably oleaginous formulations of the invention comprise electret particles having a volume mean diameter of ≥12 μm, and preferably from 10 to 40 μm, and most preferably from 10-30 μm or 10-15 μm.

In some embodiments, the composition further comprises a solvent selected from the group consisting of acetone, DMSO, water/emulsifier, a glycol, glycerin, alcohols (e.g., ethanol), petroleum distillates, ethyl acetate, toluene, xylene, dioxane, ethers, tetrahydrofuran, dichloromethane, acetonitrile, and combinations thereof.

As referred to and described herein, including the claims, the term “glycol” refers to organic compounds with two hydroxyl (—OH) groups attached to different carbon atoms of a molecular chain, including glycerol that contains 3 hydroxyl groups. Furthermore, as referred to and described herein, including the claims, the term “glycol-related” compounds are organic compounds that may have a similar chemical structure to glycols where one or more of the hydroxyl groups have been transformed or modified (e.g. glycol ether, glycol ester, or glycol acetate) with one of an ether group (an oxygen atom connected to two alkyl or aryl groups), an ester group (a hydroxyl group modified to become an oxygen-alkyl group), or acetyl group.

In some embodiments, the composition further comprises a solvent selected from the group consisting of ethylene glycol, propylene glycol, hexylene glycol, diethylene glycol, dipropylene glycol, triethylene glycol, tripropylene glycol, tetraethylene glycol, glycerin, and combinations thereof.

In some embodiments, the active ingredient portion of the composition may consist essentially of massoia essential oil, one or more massoia essential oil component, and/or one or more analog of the one or more massoia essential oil component. In some embodiments, the active ingredient portion of the composition may consist essentially of massoia essential oil. In some embodiments, the active ingredient portion of the composition may consist essentially of one or more massoia essential oil component. In some embodiments, the active ingredient portion of the composition may consist essentially of one or more analog of the one or more massoia essential oil component.

In other embodiments, the active ingredient portion of the composition may additionally include one or more other agent. For example, the active ingredient portion of the composition may additionally include one or more arthropod repellent and/or insecticide (in addition to massoia essential oil, one or more massoia essential oil component, and/or one or more analog of the one or more massoia essential oil component). Suitable arthropod repellents/insecticides include, but are not limited to, DEET, icaridin/picaridin, ethyl butylacetylaminopropionate (IR3535), citronella oil, permethrin, 2-undecanone, methyl jasmonate, benzaldehyde, p-menthane-3,8-diol, transfluthrin, metofluthrin, natural pyrethrins, trans-d-allethrin, prallethrin, alpha-terpineyl isovalerate, benzyl benzoate, ethyl hexanediol, diethyl phthalate, diethyl carbate, geraniol, citronellol, citronellal, citral, oil of lemon eucalyptus, cinnamaldehyde, and nootkatone.

In another example, the active ingredient portion of the composition may additionally include one or more conventional volatile spatial repellent (in addition to massoia essential oil, one or more massoia essential oil component, and/or one or more analog of the one or more massoia essential oil component). Suitable conventional volatile spatial repellents typically include one or more active insect repellent ingredient (e.g., a pyrethroid insecticide, a combination of pyrethroids, saltidin (also known as picaridin and icaridin), para-menthane-3,8-diol (also known as p-Menthane-3,8-diol, PMD, and methoglycol), and/or a natural insect repellent) and one or more solvent (e.g., a glycol solvent, a petroleum distillate, or a water-based formula incorporating glycol ethers in the formula). Suitable pyrethroid insecticides for use in conventional volatile spatial repellents include, but are not limited to, d-allethrin, prallethrin, transfluthrin, and metofluthrin. Suitable natural insect repellents for use in conventional volatile spatial repellents, include but are not limited to, natural oils or other natural ingredients such as lemon eucalyptus oil, lavender, cinnamon oil, thyme oil, Greek catmint oil, soybean oil, citronella, tea tree oil, geraniol, and neem oil.

In yet another example, the active ingredient portion of the composition may additionally include one or more pyrethrin and/or pyrethroid (in addition to massoia essential oil, one or more massoia essential oil component, and/or one or more analog of the one or more massoia essential oil component). Suitable pyrethrins/pyrethroids include, but are not limited to, natural pyrethrins, pyrethrin I, pyrethrin II, permethrin, tetramethrin, metofluthrin, bifenthrin, kappa-bifenthrin, kadethrin, allethrin, bioallethrin, cyfluthrin, beta-cyfluthrin, deltamethrin, cypermethrin, alpha-cypermethrin, beta-cypermethrin, theta-cypermethrin, zeta-cypermethrin, cyphenothrin, esfenvalerate, fenvalerate, flumethrin, tefluthrin, kappa-tefluthrin, phenothrin, etofenprox, fluvalinate, acrinathrin, halfenprox, flubrocythrinate, bioethanomethrin, brofenvalerate, brofluthrinate, bromethrin, butethrin, chlorempenthrin, empenthrin (vaporthrin), cylethrin, cycloprothrin, cyhalothrin, gamma-cyhalothrin, lambda-cyhalothrin, dimethfluthrin, dimethrin, empenthrin, chloroprallethrin, fenfluthrin, fenpirithrin, fenpropathrin, flucythrinate, fluvalinate, tau-fluvalinate, furamethrin, furethrin, heptafluthrin, imiprothrin, japothrins, methothrin, metofluthrin, epsilon-metofluthrin, momfluorothrin, epsilon-momfluorothrin, pentmethrin, biopermethrin, transpermethrin, profluthrin, proparthrin, pyresmethrin, renofluthrin, meperfluthrin, resmethrin, bioresmethrin, cismethrin, terallethrin, tetramethylfluthrin, tralocythrin, tralomethrin, valerate, flufenprox, halfenprox, protrifenbute, silafluofen, sulfoxime, thiofluoximate, and transfluthrin.

In some embodiments, the one or more arthropod is a mosquito selected from the group consisting of Aedes aegypti, Aedes taeniorhynchus, Anopheles albimamis, Anopheles quadrimaculatus, and Culex quinquefasciatus.

In some embodiments, the one or more arthropod is a mosquito selected from the group consisting of Aedes infirmatus, Aedes tormentor, Anopheles crucians, Culex erraticus, Culex nigripalpus, and Culiseta melamira.

In some embodiments, the one or more arthropod is a mosquito selected from the group consisting of Calex spp., Aedes spp., Anopheles spp., Psorophora spp., Mansonia spp., and Coquillettidia spp. In some embodiments, the Culex spp. is selected from the group consisting of Culex pipiens pallens (common mosquito), Culex pipiens pipiens, Culex pipiens mollestus, Culex tritaemorhynchus, Culex restuans, Culex quinquefasciatus, Culex tarsalis; wherein the Aedes spp. is selected from the group consisting of Aedes aegypti (yellow fever mosquito), Aedes albopictus, Aedes vexans, Aedes triseriatus, Aedes taeniorhynchus, Aedes scapularis; wherein the Anopheles spp. is selected from the group consisting of Anopheles sinensis, Anopheles gambiae, Anopheles stephensi, Anopheles darlingi, Anopheles aquasalis, Anopheles albitarsis, Anopheles marajoara, Anopheles funestus, Anopheles arabiensis, Anopheles merus, Anopheles nili, Anopheles dirus, Anopheles minimus s.l. Anopheles sudaicus s.l.; wherein the Psorophora spp. is selected from the group consisting of Psorophora ciliata, Psorophora columbiae, and Psorophora ferox; wherein the Mansonia is selected from the group consisting of Mansonia titillans and Mansonia dyari; and wherein the Coquillettidia spp. is selected from the group consisting of Coquillettidia perturbans and Coquillettidia nigricans.

In some embodiments, the one or more arthropod is a fly selected from the group consisting of Stomoxys calcitrans, Musca domestica, Sarcophagidae sp., Platypezidae sp., Synthesiomyia midiseta, Otitidae sp., Muscina stabulans, Chrysomya ruffifacies, Lucilia Mexicana, Lucilia sericata, Cochliomyia macellaria, and Chrysomya megacephala.

In some embodiments, the one or more arthropod is a biting midge such as Culicoides spp. The most common biting midges are Culicoides spp. In some embodiments, the Culicoides spp. is selected from the group consisting of Culicoides baueri, Culicoides insignis, Culicoides tissoti, and Culicoides venustus.

In some embodiments, the one or more arthropod is selected from the group consisting of as Leptotrombidium mites (vector for scrub typhus), Sarcoptid mites, Triatomine “kissing” bugs (vector for Chagas disease), Liohippelates (eye gnats), Sarcophagidae (flesh flies), Calliphoridae (carrion flies), Simuliidae (black flies), Glossinidae (‘Tse-tse” fly), Cimicidae (bed bugs), Psychodid (phlebotomine) flies (sand flies), Tabanidae (horse-flies and deer flies), fleas, aphids, stink bugs, beetles, lepidopterans, wasps, cockroaches, termites, and ticks.

In certain embodiments, the arthropods repelled by the compositions or methods disclosed herein are insects. In certain embodiments, the insects repelled by the compositions or methods disclosed herein are Hemiptera Insects, selected from Delphacidae (planthoppers), such as Laodelphax striatellus (small brown planthopper), Nilaparvata lugens (brown planthopper), Sogatella furcifera (white-backed rice planthopper); Deltocephalidae (leafhoppers), such as Nephotettix cincticeps (green rice leafhopper), Recilia dorsalis (zig-zag rice leaf hopper), Nephotettix virescens (green rice leafhopper); Aphididae (aphids), stink bugs, Aleyrodidae (whiteflies), scales, Tingidae (lace bugs), or Psyllidae (suckers).

In certain embodiments, the insects repelled by the compositions or methods disclosed herein are Lepidoptera Insects, selected from Pyralidae, such as Chilo suppressalis (rice stem borer), Cnaphalocrocis medinalis (rice leafroller), Plodia interpunctella (Indian meal moth); Noctuidae, such as Spodoptera litura (tobacco cutworm), Pseudaletia separata (rice armyworm), Mamestra brassicae (cabbage armyworm); Pieridae, such as Pieris rapae crucivora (common cabbageworm); Tortricidae, such as Adoxophyes spp., Carposinidae; Lyonetiidae; Lymantriidae; Plusiinae; Agrotis spp. such as Agrotis segetum (turnip cutworm), or Agrotis ipsilon (black cutworm); Helicoverpa spp.; Heliothis spp.; Plutella xylostella; Parnara guttata (rice skipper); Tinea pellionella (casemaking clothes moth), or Tineola bisselliella (webbing clothes moth).

In certain embodiments, the insects repelled by the compositions or methods disclosed herein are Diptera Insects, Culex spp., such as Culex pipiens pallens (common mosquito), Culex tritaeniorhynchus, Aedes spp., such as Aedes aegypti, Aedes albopictus; Anopheles spp., such as Anopheles sinensis; Chironomidae (midges); Muscidae, such as Musca domestica (housefly), Muscina stabulans (false stablefly), Fannia canicularis (little housefly); Calliphoridae; Sarcophagidae; Anthomyiidae, such as Delia platura (seedcorn maggot), Delia antiqua (onion maggot), Tephritidae (fluit flies); Drosophilidae; Psychodidae (moth flies), Tabanidae; Simuliidae (black flies); Stomoxyidae (stable flies); Phoridae; or Ceratopogonidae (biting midges).

In certain embodiments, the insects repelled by the compositions or methods disclosed herein are Coleoptera Insects (Beetles), several nonlimiting examples of which include Corn rootworms, such as Diabrotica virgifera (western corn rootworm), Diabrotica undecimpunctata howardi (southern corn rootworm), Scarabaeidae (scarabs), such as Anomala cuprea (cupreous chafer), Anomala rufocuprea (soybean beetle); Curculionidae (weevils), such as Sitophilus zeamais (maize weevil), Lissorhoptrus oryzophilus (ricewater weevil), ball weevil, Callosobruchus chinensis (adzuki bean weevil); Dermestidae, such as Authremis verbasci (varied carpet beetle), Attagemuis unicolor japonicus (black carpet beetle); Tenebrionidae (darkling beetles), such as Tenebrio molitor (yellow mealworm), or Tribolium castaneum (red flour beetle); Chrysomelidae (leaf beetles) such as Oulema oryzae (rice leaf beetle), Phyllotreta striolata (striped flea beetle), Aulacophora femoralis (cucurbit leaf beetle); Anobiidae; Epilachna spp. such as Epilachna vigintioctopunctata (twenty-eight-spotted ladybird); Lyctidae (powderpost beetles), Bostrychidae (false powderpost beetles), or Cerambycidae, Paederus juscipes (robe beetle).

In certain embodiments, the insects repelled by the compositions or methods disclosed herein are Dictyoptera Insects, such as the following: Blattella germanica (German cockroach); Periplaneta fuliginosa (smokybrown cockroach); Periplaneta americana (American cockroach); Periplaneta brunnea (brown cockroach); or Blatta orientalis (oriental cockroach).

In certain embodiments, the insects repelled by the compositions or methods disclosed herein are Thysanoptera Insects (Thrips), such as Thrips palmi, Flankliniella occidentalis (western flower thrips), or Thrips hawauensis (flower thrips).

In certain embodiments, the insects repelled by the compositions or methods disclosed herein are Hymenoptera Insects, such as Formicidae (ants); Vespidae (hornets); Polistes spp. (long-legged wasps); Bethylidae; or Tenthredinidae (sawflies), such as Athalis rosae nificornis (cabbage sawfly).

In certain embodiments, the insects repelled by the compositions or methods disclosed herein are Orthoptera Insects, such as Gryllotalpidae (mole crickets); or Acrididae (grasshoppers).

In certain embodiments, the insects repelled by the compositions or methods disclosed herein are Siphonaptera Insects (Fleas), such as Ctenocephalides canis (dog flea); Ctenocephalides fells (cat flea); or Pulex irritans.

In certain embodiments, the insects repelled by the compositions or methods disclosed herein are Anoplura Insects (Lice), such as Pediculus corporis (body louse); Pediculus humamis (head louse); or Pthirus pubis (crab louse).

In certain embodiments, the insects repelled by the compositions or methods disclosed herein are Isoptera Insects, such as Reticuliterrnes speratus; Coptotermes formosanus (Formosan subterranean termite).

In certain embodiments, the insects repelled by the compositions or methods disclosed herein are Harmful Acarina, such as Ixodidae (Ticks): Boophilus microplus; Haemaphysalis longiconis Tetranychidae (spider mites): Tetranychus cinnabarimis (carmine spider mite); Tetranychus urticae (two-spotted spider mite); Tetranychus kanzawai (Kanzawa spider mite); Panonychus citri (citrus red mite); Panonychus ulmi (European red mite); House-dust Mites: Acaridae such as Tyrophagus putrescentiae (copra mite), Aleuroglyphus ovatus (brown legged grain mite); Dermanyssidae such as Dermatophagoides farinae (American house dust mite), Dermatophagoides pteronyssimus; mites parasitizing honeybees, such as Varroa jacobsoni; Euvarroa sinhai, Acarapis woodi; Tropilaelaps clareae; Glycyphagidae, such as Glycyphagus privatus, Glycyphagus domesticus, Glycyphagus destructor; Cheyletidae, such as Chelacaropsis malaccensis, Cheyletus fortis; Tarsonemidae; Chortoglyphus spp.; Haplochthonius spp. Chilognatha (millipedes), such as Oxydus spp.; Chilopoda (centipedes), such as red centipede; wood lice, such as Porcellio spp., Porcellionides spp.; and pill bugs, such as Armadillidium spp.

In certain embodiments, the arthropod repelled by the compositions or methods disclosed herein is selected from the group consisting of a fly, spider, butterfly, crab, mosquito, centipede, tick, millipede, and scorpion. In certain embodiments, the arthropod repelled by the compounds, compositions, or methods disclosed herein is selected from the group consisting of a fly, spider, butterfly, crab, mosquito, centipede, tick, millipede, scorpion, roach, ant, termite, silverfish, and wasp. In certain embodiments, the arthropod is an insect.

FIGS. 10-12 are cross-sectional, exploded, and enlarged views, respectively, of an exemplary repellent dispensing device 10 that may be utilized for treating an area with a composition comprising an arthropod repelling effective amount of massoia essential oil, one or more massoia essential oil component, and/or one or more analog of the one or more massoia essential oil component, according to one or more embodiments. The exemplary repellent dispensing device 10 is based on the insect repeller disclosed in WO2022/216875A1, but modified to contain and dispense an arthropod repelling effective amount of a repellent composition comprising massoia essential oil, one or more massoia essential oil component, and/or one or more analog of the one or more massoia essential oil component. WO2022/216875A1 is incorporated by reference in its entirety.

The exemplary repellent dispensing device 10 is a nonlimiting example of an applicator that utilizes a heating element for applying to an area an arthropod repelling effective amount of a repellent composition comprising massoia essential oil, one or more massoia essential oil component, and/or one or more analog of one or more massoia essential oil component. One skilled in the art will appreciate that other applicators, both with and without a heating element, may be used for applying an arthropod repelling effective amount of the composition to an object or area. Examples of other suitable applicators include, but are not limited to, those disclosed in U.S. Pat. Nos. 11,517,006; 11,350,624; 11,266,141; 10,638,743; 10,357,033; 10,271,538; 10,137,464; 10,051,852; 9,497,958; and 9,127,833; and U.S. Patent Application Pub. Nos. 2024/0008472; 2023/0292729; and 2023/0285993, each of which is incorporated by reference in its entirety.

The repellent dispensing device 10 is presented as an example of an insect repellent dispenser utilizing a repellent formulation in accordance with the invention and may be configured in other forms. The repellent dispensing device 10 includes a base 12 that locates and supports a repellent reservoir 14 and a power source 16, configured as a rechargeable battery, capable of powering a heating element 18. In accordance with some embodiments the present invention, the repellant reservoir 14 contains the repellent composition comprising massoia essential oil, one or more massoia essential oil component, and/or one or more analog of the one or more massoia essential oil component. In one embodiment, the heating element may be a cylindrical heating element having a power output of about 3-4 W. The heating element 18 may be supported within a cover 20, though the heating element may also be supported on the base 12 or as part of a separate housing structure (not shown). The cover 20 may provide electrical contact between the battery 16 and the heating element 18. In one embodiment, the base and cover may be formed from a thermoplastic such as Acrylonitrile Butadiene Styrene (ABS) plastic.

The repellent reservoir 14 includes a fluid containment vessel portion or bottle 22. In one embodiment, the bottle 22 is formed from a thermoplastic such as polycarbonate. The reservoir 14 includes a top portion 24 that supports a wick 26 and a sealing structure 28, configured in one embodiment as a nitrile O-ring. The chemical compatibility of the various structural component materials with the repellent composition, and fluid uptake compatibility of the formulation with the wick structure are influential in developing a commercially viable and efficacious insect repellent dispensing device.

The wick 26 may be configured as a fibrous, capillary structure formed from natural or artificial fibers or formed from composite or ceramic materials including sintered materials. Typical wicks that may be used with the various repellent composition embodiments utilize composite construction, including ingredients such as polyethylene terephthalate, acrylic compounds, or ceramics. In one embodiment, the porosity of the wick may be in a range of 40 to 70% and density from 0.40 to 0.80 mg/mm³. In another embodiment, the wick porosity may be in a range of 50-60% and have a density of 0.55-0.65 mg/mm³. The influence of wick characteristics is balanced with the viscosity of the selected solvent (e.g., glycol), solubility of active ingredient in the selected solvent, and the concentration of active ingredient. These factors are balanced with the level of heat output to provide a formulation that enables it to travel through the pores in the wick and vaporize at a rate to create a concentration of active ingredient sufficient to repel the target arthropod.

As shown in FIG. 10, the exposed area of the wick 26 is positioned proximate to and generally within the heater 18. As heat is applied to a wick end 26a proximate to the heater, the repellent composition contained in that area is volatized and the active ingredient emitted into the surrounding area. In some embodiments, a target temperature range from about 60° C. to about 140° C. provides sufficient volatilization of the massoia essential oil, one or more massoia essential oil component, and/or one or more analog of the one or more massoia essential oil component in the repellent composition. For example, as discussed above with respect to the modified repellency assay shown in FIG. 9A, a target temperature of about 155° F. (68.3° C.) significantly increases the repellency of massoia essential oil as compared room temperature passive emanation. As the material leaves the wick, a pressure differential created by exiting material permits the capillary action to draw more fluid up towards the wick proximate end. The amount of heat radiant energy available to volatize the repellent composition is an influential factor, particularly in the context of a portable insect repellent dispensing device. In order to create a commercially-viable, portable insect repellent dispensing device, unit size, battery charge life, and heater output are designed in consideration of the repellent composition properties.

Because of demonstrated effectiveness and regulatory acceptance, synthetic pyrethroids such as, for example, metofluthrin and transfluthrin are good candidates for the active ingredient portion of the repellent composition, along with massoia essential oil, one or more massoia essential oil component, and/or one or more analog of the one or more massoia essential oil component. Alternatively, other synthetic or natural repellent materials may be used, along with massoia essential oil, one or more massoia essential oil component, and/or one or more analog of the one or more massoia essential oil component.

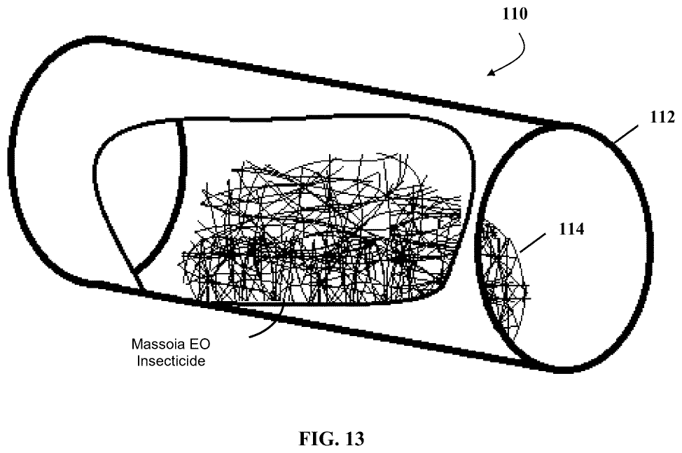

FIG. 13 is a schematic perspective view of an exemplary tick control tube 110 containing a substrate 114 impregnated with an insecticide composition comprising an arthropod-killing effective amount/concentration of massoia essential oil, one or more massoia essential oil component, and/or one or more analog of the one or more massoia essential oil component, according to one or more embodiments. The exemplary tick control tube 110 is based on the tick control tube disclosed in US2022/0201976A1, but modified to contact an arthropod's environment with an insecticide composition comprising an arthropod killing effective amount of a repellent composition comprising massoia essential oil, one or more massoia essential oil component, and/or one or more analog of the one or more massoia essential oil component. US2022/0201976A1 is incorporated by reference in its entirety.

The exemplary tick control tube 110 is a nonlimiting example of an applicator that utilizes a substrate for contacting an arthropod or its environment with an arthropod-killing effective amount/concentration of an insecticide composition comprising massoia essential oil, one or more massoia essential oil component, and/or one or more analog of one or more massoia essential oil component. One skilled in the art will appreciate that other applicators, both with and without a substrate, may be used for contacting an arthropod or its environment with an arthropod killing effective amount of the insecticide composition. Examples of other suitable applicators include, but are not limited to, foggers, ultra-low volume sprayers, indoor residual sprayers, space sprayers, or other suitable conventional application devices.

The tick control tube 110 includes a carrier member 112 and a substrate 114 configured as bedding material. In one embodiment, the carrier member 112 is configured as a cardboard tube. The substrate/bedding material 114 is a treated bedding material that is impregnated with an massoia essential oil, one or more massoia essential oil component, and/or one or more analog of the one or more massoia essential oil component, as well as an oral deterrent. In one aspect of the invention, the substrate/bedding material 114 is a fibrous material and may be at least in part a fibrous natural material or a fibrous polymer material having a consistency or appearance similar to medical or cosmetic cotton balls. The fibrous material may be cotton, cotton-based, wool, wool-based, polyester or another polymer-based material comprising entangled filaments of the material. The substrate/bedding material 114 is treated with massoia essential oil, one or more massoia essential oil component, and/or one or more analog of the one or more massoia essential oil component and, optionally, a permethrin as an example of a suitable conventional acaricide. Other examples of suitable conventional acaricides include, but are not limited to, carbaryl, bifenthrin, cyfluthrin, permethrin, nootkatone, and fipronil.

The substrate/bedding material 114 is also treated with the oral deterrent configured as a compound of denatonium, such as denatonium benzoate (known as Bitrex®, registered trademark of Johnson Matthey Public Limited Company, United Kingdom), denatonium saccharide, or denatonium chloride. The substrate/bedding material 114 may be treated with a solution of massoia essential oil, one or more massoia essential oil component, and/or one or more analog of the one or more massoia essential oil component, as well as the oral deterrent and a volatile carrier medium, such as alcohol (for example methyl alcohol, ethyl alcohol, isopropyl alcohol) and, optionally, a conventional acaricide. In one embodiment, during manufacture massoia essential oil, one or more massoia essential oil component, and/or one or more analog of the one or more massoia essential oil component, as well as the conventional acaricide and oral deterrent are mixed with a suitable solvent (e.g., isopropanol) to form a solution. The substrate/bedding material 114 is soaked in the solution and heated to drive off the solvent.

“Optional” or “optionally” means that the subsequently described event or circumstance may or may not occur, and that the description includes instances in which said event or circumstance occurs and instances where it does not. For example, the phrase “optionally comprising a conventional volatile spatial repellent” means that the composition may or may not contain a conventional volatile spatial repellent and that this description includes compositions that contain and do not contain a conventional volatile spatial repellent. Also, by example, the phrase “optionally adding a conventional volatile spatial repellent” means that the method may or may not involve adding a conventional volatile spatial repellent and that this description includes methods that involve and do not involve adding a conventional volatile spatial repellent.

By the term “effective amount” of a compound or property as provided herein is meant such amount as is capable of performing the function of the compound or property for which an effective amount is expressed. As will be pointed out below, the exact amount required will vary from process to process, depending on recognized variables such as the compounds employed and the processing conditions observed. Thus, it is not possible to specify an exact “effective amount.” However, an appropriate effective amount may be determined by one of ordinary skill in the art using only routine experimentation.

While this invention may be embodied in many different forms, there are described in detail herein specific preferred embodiments of the invention. The present disclosure is an exemplification of the principles of the invention and is not intended to limit the invention to the particular embodiments illustrated. All patents, patent applications, scientific papers, and any other referenced materials mentioned herein are incorporated by reference in their entirety. Furthermore, the invention encompasses any possible combination of some or all of the various embodiments and characteristics described herein and/or incorporated herein. In addition, the invention encompasses any possible combination that also specifically excludes any one or some of the various embodiments and characteristics described herein and/or incorporated herein.

The amounts, percentages and ranges disclosed herein are not meant to be limiting, and increments between the recited amounts, percentages and ranges are specifically envisioned as part of the invention. All ranges and parameters disclosed herein are understood to encompass any and all subranges subsumed therein, and every number between the endpoints. For example, a stated range of “1 to 10” should be considered to include any and all subranges between (and inclusive of) the minimum value of 1 and the maximum value of 10 including all integer values and decimal values; that is, all subranges beginning with a minimum value of 1 or more, (e.g., 1 to 6.1), and ending with a maximum value of 10 or less, (e.g. 2.3 to 9.4, 3 to 8, 4 to 7), and finally to each number 1, 2, 3, 4, 5, 6, 7, 8, 9, and 10 contained within the range.

Unless otherwise indicated, all numbers expressing quantities of ingredients, properties such as molecular weight, reaction conditions (e.g., reaction time, temperature), percentages and so forth as used in the specification and claims are to be understood as being modified in all instances by the term “about.” Accordingly, unless otherwise indicated, the numerical properties set forth in the following specification and claims are approximations that may vary depending on the desired properties sought to be obtained in embodiments of the present invention. As used herein, the term “about” refers to a quantity, level, value, or amount that varies by as much as 10% to a reference quantity, level, value, or amount. For example, about 1.0 g means 0.9 g to 1.1 g and all values within that range, whether specifically stated or not.

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described.

The term “consisting essentially of” excludes additional method (or process) steps or composition components that substantially interfere with the intended activity of the method (or process) or composition, and can be readily determined by those skilled in the art (for example, from a consideration of this specification or practice of the invention disclosed herein). The invention illustratively disclosed herein suitably may be practiced in the absence of any element (e.g., method (or process) steps or composition components) which is not specifically disclosed herein. Thus, the specification includes disclosure by silence (“Negative Limitations In Patent Claims,” AIPLA Quarterly Journal, Tom Brody, 41 (1): 46-47 (2013): “ . . . Written support for a negative limitation may also be argued through the absence of the excluded element in the specification, known as disclosure by silence . . . . Silence in the specification may be used to establish written description support for a negative limitation. As an example, in Ex parte Lin [No. 2009-0486, at 2, 6 (B.P.A.I. May 7, 2009)] the negative limitation was added by amendment . . . . In other words, the inventor argued an example that passively complied with the requirements of the negative limitation . . . was sufficient to provide support . . . . This case shows that written description support for a negative limitation can be found by one or more disclosures of an embodiment that obeys what is required by the negative limitation . . . .”

Other embodiments of the invention will be apparent to those skilled in the art from a consideration of this specification or practice of the invention disclosed herein. It is intended that the specification and examples be considered as exemplary only, with the true scope and spirit of the invention being indicated by the following claims.

What is claimed is:

1. A method of repelling one or more arthropod, said method comprising treating an object or area with a composition comprising an arthropod repelling effective amount of massoia essential oil, one or more massoia essential oil component, and/or one or more analog of the one or more massoia essential oil component.

2. The method of claim 1, wherein the composition includes the massoia essential oil.

3. The method of claim 1, wherein the composition includes the one or more massoia essential oil component, wherein the one or more component is/are selected from the group consisting of 4-hydroxy-4-methyl-2-pentanone; α-funebrene; 5,6-dihydro-6-pentyl-2H-pyran-2-one (C-10-massoia lactone); massoilactone; delta-decalatone; ethyl 4-ethoxybenzoate; diethyl phthalate; cedrol; 17-octadecynoic acid; 6-nonyl-5,6-dihydro-2H-pyran-2-one; C-14-massoia lactone; 6-heptyl-5,6-dihydro-2H-pyran-2-one; C-12-massoia lactone; 1,12-tridecadiene; benzyl benzoate; 1-nonadecene; hexacosene; 2-(ocyadecyloxy)-ethanol; heneicosane; 3-ethyl-5-(2-ethylbutyl) octadecane; heptacosane; and nonahexacontanoic acid.

4. The method of claim 3, wherein the composition includes at least C-10-massoia lactone as the one or more component.

5. The method of claim 1, wherein the composition includes the one or more analog of the one or more massoia essential oil component, wherein the one or more analog is/are selected from the group consisting of α-amyl-pyrone; γ-undecalactone; δ-undecalactone; jasmolactone; 5-dodecanolide; and δ-damascone.

6. The method of claim 5, wherein the composition includes at least α-amyl-pyrone as the one or more analog.

7. The method of claim 1, wherein the composition further comprises one or more arthropod repellents and/or insecticides selected from the group consisting of DEET, icaridin/picaridin, ethyl butylacetylaminopropionate (IR3535), citronella oil, permethrin, 2-undecanone, methyl jasmonate, benzaldehyde, p-menthane-3,8-diol, transfluthrin, metofluthrin, natural pyrethrins, trans-d-allethrin, prallethrin, alpha-terpineyl isovalerate, benzyl benzoate, ethyl hexanediol, diethyl phthalate, diethyl carbate, geraniol, citronellol, citronellal, citral, oil of lemon eucalyptus, cinnamaldehyde, and nootkatone.

8. The method of claim 1, wherein the composition further comprises one or more conventional volatile spatial repellent.

9. The method of claim 1, wherein the composition further comprises one or more pyrethrin and/or pyrethroid selected from the group consisting of natural pyrethrins, pyrethrin I, pyrethrin II, permethrin, tetramethrin, metoflurthrin, bifenthrin, kappa-bifenthrin, kadethrin, allethrin, bioallethrin, cyfluthrin, beta-cyfluthrin, deltamethrin, cypermethrin, alpha-cypermethrin, beta-cypermethrin, theta-cypermethrin, zeta-cypermethrin, cyphenothrin, esfenvalerate, fenvalerate, flumethrin, tefluthrin, kappa-tefluthrin, phenothrin, etofenprox, fluvalinate, acrinathrin, halfenprox, flubrocythrinate, bioethanomethrin, brofenvalerate, brofluthrinate, bromethrin, butethrin, empenthrin (vaporthrin), cylethrin, cycloprothrin, cyhalothrin, gamma-cyhalothrin, lambda-cyhalothrin, dimethfluthrin, dimethrin, empenthrin, chloroprallethrin, fenfluthrin, fenpirithrin, fenpropathrin, flucythrinate, fluvalinate, tau-fluvalinate, furamethrin, furethrin, heptafluthrin, imiprothrin, japothrins, methothrin, metofluthrin, epsilon-metofluthrin, momfluorothrin, epsilon-momfluorothrin, pentmethrin, prallethrin, biopermethrin, transpermethrin, profluthrin, proparthrin, pyresmethrin, renofluthrin, meperfluthrin, resmethrin, bioresmethrin, cismethrin, terallethrin, tetramethylfluthrin, tralocythrin, tralomethrin, valerate, flufenprox, halfenprox, protrifenbute, silafluofen, sulfoxime, thiofluoximate, and transfluthrin.

10. The method of claim 1, wherein the one or more arthropod is a mosquito selected from the group consisting of Aedes aegypti, Aedes taeniorhynchus, Anopheles albimanus, Anopheles quadrimaculatus, and Culex quinquefasciatus.

11. The method of claim 1, wherein the one or more arthropod is a mosquito selected from the group consisting of Aedes infirmatus, Aedes tormentor, Anopheles crucians, Culex erraticus, Culex nigripalpus, and Culiseta melanura.

12. The method of claim 1, wherein the one or more arthropod is a mosquito selected from the group consisting of Culex spp, Aedes spp., Anopheles spp., Psorophora spp., Mansonia spp, and Coquillettidia spp.

13. The method of claim 12, wherein the Culex spp is selected from the group consisting of Culex pipiens pallens (common mosquito), Culex pipiens pipiens, Culex pipiens mollestus, Culex tritaeniorhynchus, Culex restrans, Culex quinquefascianis, Culex tarsalis; wherein the Aedes spp. is selected from the group consisting of Aedes aegypti (yellow fever mosquito), Aedes albopictus, Aedes vexans, Aedes triseriatus, Aedes taeniorynchus, Aedes scapularis; wherein the Anopheles spp. is selected from the group consisting of Anopheles sinensis, Anopheles gambiae, Anopheles stephensi, Anopheles darlingi, Anopheles aquasals, Anopheles albitarsis, Anopheles marajoara, Anopheles forestus, Anopheles arabiensis, Anopheles merus, Anopheles nili, Anopheles dirus, Anopheles minimis s.l. Anopheles sadaicus s.l.; wherein the Psorophora spp. is selected from the group consisting of Psorophora ciliata, Psorophora columbiae, and Psorophora ferox; wherein the Mansonia is selected from the group consisting of Mansoma titillans and Mansonia dyari; and wherein the Coquillettidia spp is selected from the group consisting of Coquillettidia perturbans and Coquillettidia nigricans.

14. The method of claim 1, wherein the one or more arthropod is a fly selected from the group consisting of Stomoxys calcitrans, Musca domestica, Sarcophagidae sp., Platypezidae sp., Synthesiomyia midiseta, Otitidae sp., Muscina stabulans, Chrysomya ruffifacies, Lucilia Mexicana, Lucilia sericata, Cochliomyia macellaria, and Chrysomya megacephala.

15. The method of claim 1, wherein the one or more arthropod is a biting midge selected from the group consisting of Culicoides baueri, Culicoides insignis, Culicoides tissoti, and Culicoides venuistus.

16. The method of claim 1, wherein the one or more arthropod is selected from the group consisting of as Leptotrombidium mites (vector for scrub typhus), Sarcoptid mites, Triatomine “kissing” bugs (vector for Chagas disease), Liohippelates (eye gnats), Sarcophagidae (flesh flies), Calliphoridae (carrion flies), Simuliidae (black flies), Glossinidae (‘Tse-tse” fly), Cimicidae (bed bugs), Psychodid (phlebotomine) flies (sand flies), Tabanidae (horse-flies and deer flies), fleas, aphids, stink bugs, beetles, lepidopterans, wasps, cockroachs, termites, and ticks.

17. The method of claim 1, wherein the composition further comprises a solvent selected from the group consisting of acetone, ethanol, DMSO, water/emulsifier, a glycol, glycerin, petroleum distillates, ethyl acetate, toluene, xylene, dioxane, ethers, tetrahydrofuran, dichloromethane, acetonitrile, and combinations thereof.

18. The method of claim 1, wherein the composition further comprises a solvent selected from the group consisting of ethylene glycol, propylene glycol, hexylene glycol, diethylene glycol, dipropylene glycol, triethylene glycol, tripropylene glycol, tetraethylene glycol, glycerin, and combinations thereof.

19. The method of claim 1, wherein the composition further comprises one or more suitable synergists, propellants, carriers, diluents, adjuvants, preservatives, dispersants, solvents, and/or emulsifying agents.

20. The method of claim 1, wherein the composition is applied to a substrate.

21. The method of claim 20, the method further comprising:
applying heat to the substrate.

22. An arthropod repellent system, comprising:
a composition comprising massoia essential oil, one or more massoia essential oil component, and/or one or more analog of the one or more massoia essential oil component;
an applicator for applying an arthropod repelling effective amount of the composition to an object or area.

23. The arthropod repellent system of claim 22, wherein the applicator comprises a substrate impregnated with the composition and from which the composition evaporates.

24. The arthropod repellent system of claim 23, wherein the applicator further comprises a heating element operative to apply heat to the substrate.

25. The arthropod repellent system of claim 24, wherein the composition includes the massoia essential oil.

26. The arthropod repellent system of claim 24, wherein the composition includes the one or more massoia essential oil component, wherein the one or more component is/are selected from the group consisting of 4-hydroxy-4-methyl-2-pentanone; α-funebrene; 5,6-dihydro-6-pentyl-2H-pyran-2-one (C-10-massoia lactone); massoilactone; delta-decalatone; ethyl 4-ethoxybenzoate; diethyl phthalate; cedrol; 17-octadecynoic acid; 6-nonyl-5,6-dihydro-2H-pyran-2-one; C-14-massoia lactone; 6-heptyl-5,6-dihydro-2H-pyran-2-one; C-12-massoia lactone; 1,12-tridecadiene; benzyl benzoate; 1-nonadecene; hexacosene; 2-(ocyadecyloxy)-ethanol; heneicosane; 3-ethyl-5-(2-ethylbutyl) octadecane; heptacosane; and nonahexacontanoic acid.

27. The arthropod repellent system of claim 26, wherein the composition includes at least C-10-massoia lactone as the one or more component.

28. The arthropod repellent system of claim 24, wherein the composition includes the one or more analog of the one or more massoia essential oil component, wherein the one or more analog is/are selected from the group consisting of α-amyl-pyrone; γ-undecalactone; δ-undecalactone; jasmolactone; 5-dodecanolide; and δ-damascone.

29. The arthropod repellent system of claim 28, wherein the composition includes at least α-amyl-pyrone as the one or more analog.

30. The arthropod repellent system of claim 24, wherein the composition further comprises one or more arthropod repellents and/or insecticides selected from the group consisting of DEET, icaridin/picaridin, ethyl butylacetylaminopropionate (IR3535), citronella oil, permethrin, 2-undecanone, methyl jasmonate, benzaldehyde, p-menthane-3,8-diol, transfluthrin, metofluthrin, natural pyrethrins, trans-d-allethrin, prallethrin, alpha-terpineyl isovalerate, benzyl benzoate, ethyl hexanediol, diethyl phthalate, diethyl carbate, geraniol, citronellol, citronellal, citral, oil of lemon eucalyptus, cinnamaldehyde, and nootkatone.

31. The arthropod repellent system of claim 24, wherein the composition further comprises one or more conventional volatile spatial repellent.

32. The arthropod repellent system of claim 24, wherein the composition further comprises one or more pyrethrin and/or pyrethroid selected from the group consisting of natural pyrethrins, pyrethrin I, pyrethrin II, permethrin, tetramethrin, metoflurthrin, bifenthrin, kappa-bifenthrin, kadethrin, allethrin, bioallethrin, cyfluthrin, beta-cyfluthrin, deltamethrin, cypermethrin, alpha-cypermethrin, beta-cypermethrin, theta-cypermethrin, zeta-cypermethrin, cyphenothrin, esfenvalerate, fenvalerate, flumethrin, tefluthrin, kappa-tefluthrin, phenothrin, etofenprox, fluvalinate, acrinathrin, halfenprox, flubrocythrinate, bioethanomethrin, brofenvalerate, brofluthrinate, bromethrin, butethrin, chlorempenthrin, vaporthrin (empenthrin), cylethrin, cycloprothrin, cyhalothrin, gamma-cyhalothrin, lambda-cyhalothrin, dimethfluthrin, dimethrin, empenthrin, chloroprallethrin, fenfluthrin, fenpirithrin, fenpropathrin, flucythrinate, fluvalinate, tau-fluvalinate, furamethrin, furethrin, heptafluthrin, imiprothrin, japothrins, methothrin, metofluthrin, epsilon-metofluthrin, momfluorothrin, epsilon-momfluorothrin, pentmethrin, prallethrin, biopermethrin, transpermethrin, profluthrin, proparthrin, pyresmethrin, renofluthrin, meperfluthrin, resmethrin, bioresmethrin, cismethrin, terallethrin, tetramethylfluthrin, tralocythrin, tralomethrin, valerate, flufenprox, halfenprox, protrifenbute, silafluofen, sulfoxime, thiofluoximate, and transfluthrin.

33. The arthropod repellent system of claim 24, wherein the composition further comprises a solvent selected from the group consisting of acetone, ethanol, DMSO, water/emulsifier, a glycol, glycerin, petroleum distillates, ethyl acetate, toluene, xylene, dioxane, ethers, tetrahydrofuran, dichloromethane, acetonitrile, and combinations thereof.

34. The arthropod repellent system of claim 24, wherein the composition further comprises a solvent selected from the group consisting of ethylene glycol, propylene glycol, hexylene glycol, diethylene glycol, dipropylene glycol, triethylene glycol, tripropylene glycol, tetraethylene glycol, glycerin, and combinations thereof.

35. The arthropod repellent system of claim 24, wherein the composition further comprises one or more suitable synergists, propellants, carriers, diluents, adjuvants, preservatives, dispersants, solvents, and/or emulsifying agents.

36. The arthropod repellent system of claim 24 wherein the substrate is a mat or wick comprising cellulose, polymer, and/or ceramic.

37. A method of controlling one or more arthropod, said method comprising contacting an arthropod or its environment with an insecticide composition comprising an arthropod killing effective amount of massoia essential oil, one or more massoia essential oil component, and/or one or more analog of the one or more massoia essential oil component, wherein the one or more arthropod is not mosquito larvae.
